(19) United States
(12) Patent Application Publication
(10) Pub. No.: US 2024/0418956 A1
(43) Pub. Date: Dec. 19, 2024

(54) MODULAR FIBER OPTIC TRAY

(71) Applicant: Panduit Corp., Tinley Park, IL (US)

(72) Inventors: Thomas M. Sedor, Orland Park, IL (US); Jerry A. Wiltjer, Frankfort, IL (US); Robert A. Reid, Battle Ground, IN (US); Joseph E. Sanders, Elwood, IL (US); Joel D. Kwasny, Plainfield, IL (US); Bon B. Sledzinski, Westmont, IL (US)

(73) Assignee: Panduit Corp., Tinley Park, IL (US)

(21) Appl. No.: 18/818,728

(22) Filed: Aug. 29, 2024

Related U.S. Application Data
(63) Continuation of application No. 18/206,193, filed on Jun. 6, 2023, now Pat. No. 12,105,338.
Application No. 18/206,193 is a continuation of application No. 17/834,576, filed on Jun. 7, 2022, now Pat. No. 11,709,331.
Application No. 17/834,576 is a continuation of application No. 16/924,768, filed on Jul. 9, 2020, now Pat. No. 11,372,185.
Application No. 16/924,768 is a continuation of application No. 16/257,830, filed on Jan. 25, 2019, now Pat. No. 10,725,258.
Application No. 16/257,830 is a division of application No. 15/628,818, filed on Jun. 21, 2017, now Pat. No. 10,215,944.
(60) Provisional application No. 62/356,662, filed on Jun. 30, 2016.

(51) Int. Cl. G02B 6/44; G02B 6/38

(52) U.S. Cl. CPC G02B 6/4452; G02B 6/3897; G02B 6/4453; G02B 6/4455

(57) ABSTRACT

The present invention provides modular trays having cutout features that are configured to engage with a mounting feature of one or more removable rails. The removable rails may be removably secured to a tray body in a plurality of positions to allow a user to install or uninstall rails to support different sized fiber optic modules. For example, a tray may support a twenty-four optical fiber module, two twelve optical fiber modules, or three eight optical fiber modules. Fiber optic enclosures housing the trays can be affixed to the outside of a fiber optic enclosure and allow for easy stacking and unstacking.

### CROSS REFERENCE TO RELATED APPLICATIONS

This application is a continuation of U.S. patent application Ser. No. 18/206,193, filed Jun. 6, 2023, which is a continuation of U.S. patent application Ser. No. 17/834,576, filed on Jun. 7, 2022 (issued as U.S. Pat. No. 11,709,331 on Jul. 25, 2023), which is a continuation of U.S. patent application Ser. No. 16/924,768, filed on Jul. 9, 2020 (issued as U.S. Pat. No. 11,372,185 on Jun. 28, 2022), which is a continuation of U.S. patent application Ser. No. 16/257,830, filed on Jan. 25, 2019 (issued as U.S. Pat. No. 10,725,258 on Jul. 28, 2020), which is a divisional of U.S. patent application Ser. No. 15/628,818, filed Jun. 21, 2017 (issued as U.S. Pat. No. 10,215,944 on Feb. 26, 2019), which claims priority to U.S. Provisional Patent Application No. 62/356,662, filed Jun. 30, 2016, the entirety of all of which are hereby incorporated by reference in its entirety herein.

### BACKGROUND OF THE INVENTION

The present invention relates to data center management, and, in particular, enclosures for high speed data transport fiber cabling systems. Optical fibers allow for transmission of communications over longer distances and at higher bandwidths than wire cables. Optical fibers are also advantageous for communication systems because signals suffer less loss than wire cables and are immune to electromagnetic interference. Optical fibers are therefore often used for high bandwidth, long distance applications. One of the primary functions of a data center is to provide connections between incoming and outgoing optical fiber connections.

A user may desire to use different sized fiber optic modules housing optical fiber connections. At present, such a user installs and removes entire banks of patch panels or trays in order to accommodate different sized fiber optic modules because trays are currently designed to only support one size of fiber optic module. Thus, it may be advantageous to provide a tray that allows different sized fiber optic modules to be installed within the tray without replacing or removing the tray itself.

### SUMMARY OF THE INVENTION

The present invention is directed to a tray to support fiber optic equipment. The tray includes a tray body having a first side edge portion, a second side edge portion, a front side edge portion, a rear side edge portion and a middle portion. The middle portion of the tray body has a plurality of cutout features. The first side edge portion is configured to be secured to a first rail. The second side edge portion is configured to be secured to a second rail. The cutout features are configured to engage with a mounting feature of a third rail such that the third rail may be removably secured to the tray body in a plurality of positions.

Another embodiment of the present invention is directed to a system to support fiber optic equipment. The system includes a tray body having a first side edge portion, a second side edge portion, a front side edge portion, a rear side edge portion and a middle portion. The middle portion of the tray body has a first set of cutout features and a second set of cutout features. The system also includes a first rail secured to the first side edge portion, a second rail secured to the second side edge portion, and a third rail having a mounting feature configured to be removably secured to the first set of cutout features or the second set of cutout features.

Another embodiment of the present invention is directed to a method of supporting a plurality of sizes of fiber optic modules. The method includes inserting a mounting feature of a rail into a first set of cutout features in a tray body. The method further includes removing the mounting feature of the rail from the first set of cutout features in the tray body. The method further includes inserting the mounting feature of the rail into a second set of cutout features in the tray body.

### BRIEF DESCRIPTION OF THE DRAWINGS

FIG. 1A is a perspective view of the patch panel.

FIG. 1B is an exploded view of the patch panel of FIG. 1A.

FIG. 2A is a perspective view of the frame of the patch panel.

FIG. 2B is a front view of the frame of the patch panel.

FIG. 2C is a bottom view of the frame of the patch panel.

FIG. 3 is a perspective view of the rear of the patch panel.

FIGS. 4A and 4B are perspective and side views of the center support brackets, respectively.

FIG. 5 is a perspective view of the modular tray of the patch panel.

FIGS. 6A, 6B, and 6C are perspective views of the left, removable, and right rails of the patch panel, respectively.

FIGS. 6D and 6E are perspective views of the right and left rails of the patch panel, respectively.

FIG. 7 is a top view of the modular tray with two modules installed in the tray.

FIG. 8 is a perspective view of the modular tray with two modules installed in the tray.

FIG. 9 is a top view of the modular tray with three modules installed in the tray.

FIG. 10 is a perspective view of the modular tray with three modules installed in the tray.

FIG. 11 is a top view of the modular tray with one module installed in the tray.

FIG. 12 is a perspective view of the modular tray with one module installed in the tray.

FIGS. 13A, 13B, and 13C are top, side, and cross-section views of the removable rail of the patch panel.

FIG. 14A is a top view of a portion of the modular tray.

FIG. 14B is a cross-section view of the removable rail.

FIG. 14C is a side view of the removable rail.

FIG. 15 is a top view of the modular tray with three removable rails installed in the tray.

FIG. 16 is a top view of a portion of the modular tray with the right and left rails.

FIG. 17 is a perspective view of the modular tray with three removable rails installed in the tray.

FIG. 18 is a perspective view of a portion of the modular tray with three removable rails installed in the tray.

FIG. 19 is a perspective view of the bottom of a portion of the modular tray with three removable rails installed in the tray.

FIG. 20 is a perspective view of the left and right rails and three removable rails of the patch panel.

FIG. 21 is cross sectional views of the three removable rails of FIG. 15.

FIG. 22 is cross sectional views of the three removable rails of FIG. 15.

FIG. 23 is cross sectional views of the three removable rails of FIG. 15.

FIG. 24 is cross sectional views of the three removable rails of FIG. 15.

FIGS. 25A and 25B are side views of the two different removable rails shown in FIG. 20.

FIGS. 26A and 26B are top views of a portion of the modular tray with modules installed in the tray.

FIGS. 27A and 27B are top views of a portion of the modular tray with modules installed in the tray.

FIGS. 28A and 28B are top views of a portion of the modular tray with modules installed in the tray.

FIGS. 29A and 29B are top views of a portion of the modular tray with modules installed in the tray.

FIG. 30 is a perspective view of the rear of a High Density Fiber Enclosure (“HDFE”).

FIG. 31 is a perspective view of the rear of another embodiment of a HDFE.

FIG. 32 is a perspective view of the rear of another embodiment of a HDFE.

FIG. 33 is a perspective view of the HDFE tray with a removable rail installed in the tray.

FIG. 34 is an exploded perspective view of the HDFE tray of FIG. 33.

FIG. 35 is a perspective view of the body of the HDFE tray.

FIG. 36 is a perspective view of the HDFE tray with two removable rails installed in the tray.

FIG. 37 is a perspective view of body of the HDFE tray including right and left rails.

FIG. 38 is a perspective view of the HDFE removable rail.

FIG. 39 is an exploded perspective view of the HDFE removable rail.

FIG. 40 is a bottom perspective view of a portion of a HDFE tray and a HDFE removable rail.

FIG. 41 is a bottom perspective view of a portion of a HDFE tray with a HDFE removable rail partially installed in the tray.

FIG. 42 is a bottom perspective view of a portion of a HDFE tray with a HDFE removable rail fully installed in the tray.

FIG. 43 is a bottom perspective view of a portion of a HDFE removable rail installed in a HDFE tray.

FIG. 44 is a perspective view of a HDFE enclosure.

FIG. 45 is a front magnified view of the HDFE enclosure.

FIG. 46 is a top view of a portion of a HDFE enclosure.

FIG. 47 is an exploded perspective view of the rear of the HDFE enclosure including a removable top cover.

FIG. 48 is an exploded perspective view of the rear of the HDFE enclosure including a removable top cover.

FIG. 49 is a perspective view of the rear of the HDFE enclosure with the removable top cover installed.

FIG. 50 is a perspective view of the HDFE enclosure with a HDFE removable rail partially installed.

FIG. 51 is a side view of a HDFE modular tray with a HDFE removable rail partially installed.

FIG. 52 is a bottom perspective view of the body of a HDFE modular tray with a HDFE removable rail installed in the tray.

FIG. 53 is a top view of a HDFE modular tray with three modules installed in the tray.

FIG. 54 is a perspective view of a HDFE modular tray with three modules installed in the tray.

FIG. 55 is a top view of a HDFE modular tray with two modules installed in the tray.

FIG. 56 is a perspective view of a HDFE modular tray with two modules installed in the tray.

FIG. 57 is a top view of a HDFE modular tray with one module installed in the tray.

FIG. 58 is a perspective view of a HDFE modular tray with one module installed in the tray.

FIG. 59 is a perspective view of a modular patch panel installed on the front face of the equipment rail of a fiber optic enclosure.

FIG. 60 is another perspective view of a modular patch panel installed on the side of the equipment rail of a fiber optic enclosure.

FIG. 61 is a perspective view of a modular patch panel installed on the rear face of the equipment rail of a fiber optic enclosure.

FIG. 62 is an exploded perspective view of the modular patch panel of FIG. 61.

FIG. 63 is a perspective view of the modular patch panel.

FIG. 64 is an exploded perspective view of the modular patch panel of FIG. 63.

FIG. 65 is a cross sectional view of the modular patch panel prior to installation of an additional unit.

FIG. 66 is a cross sectional view of the modular patch panel with all units shown in FIG. 65 installed.

### DETAILED DESCRIPTION OF THE INVENTION

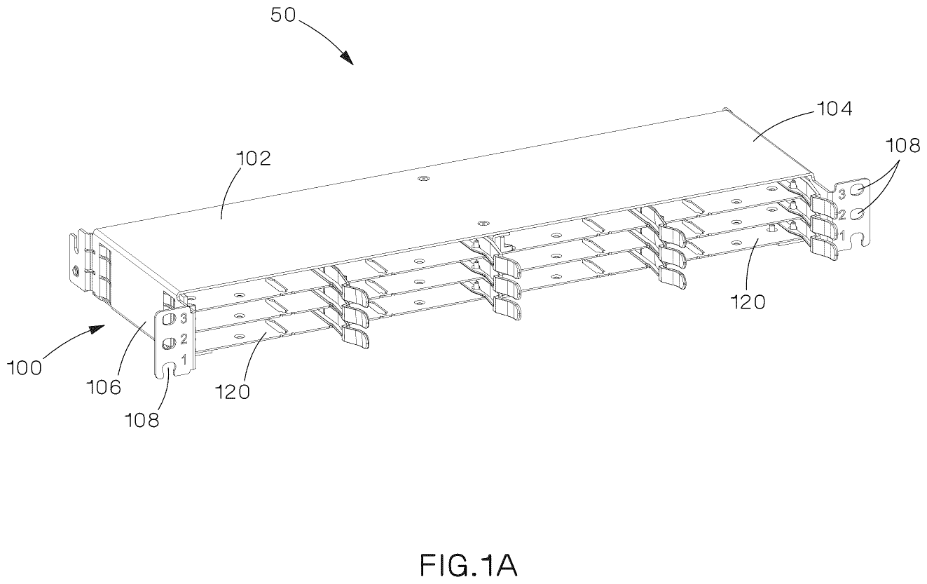

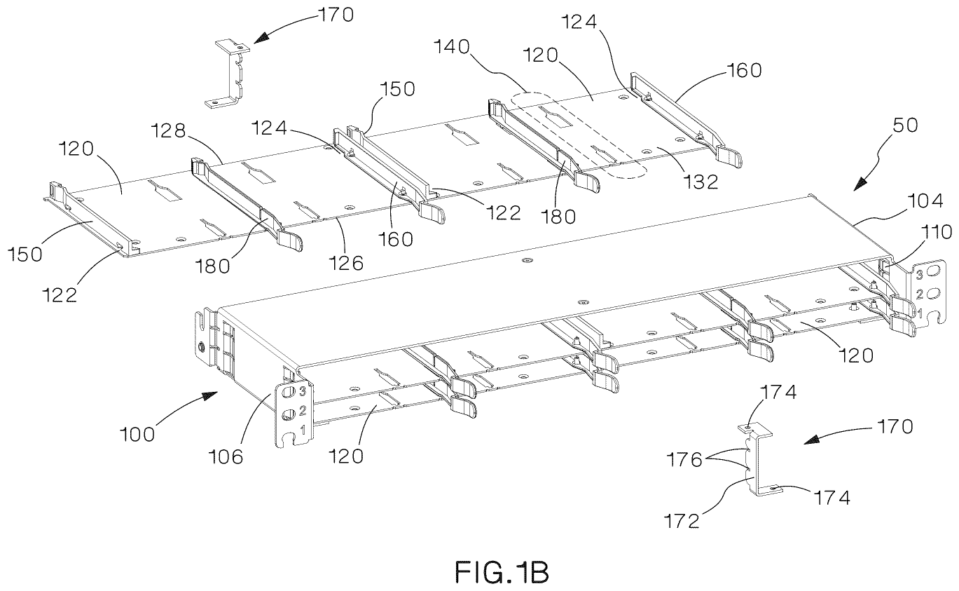

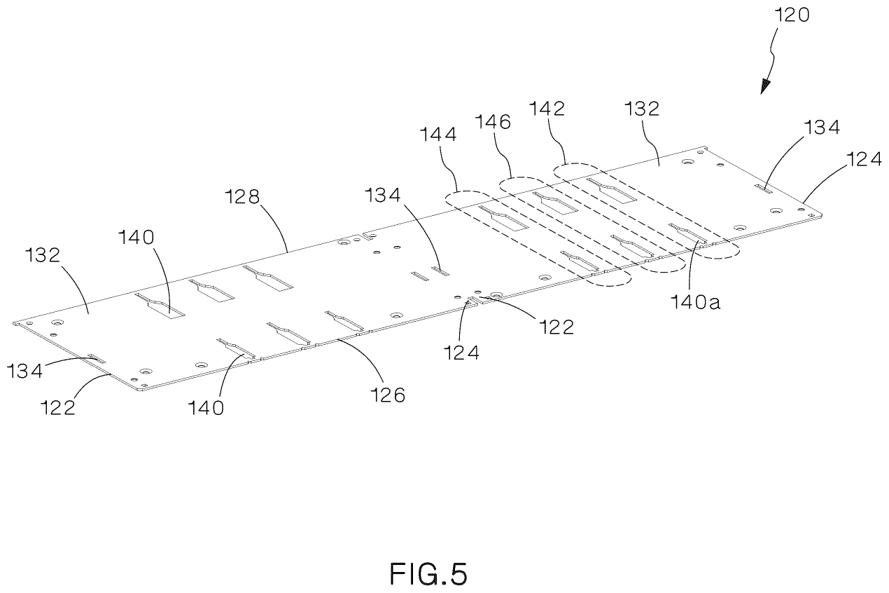

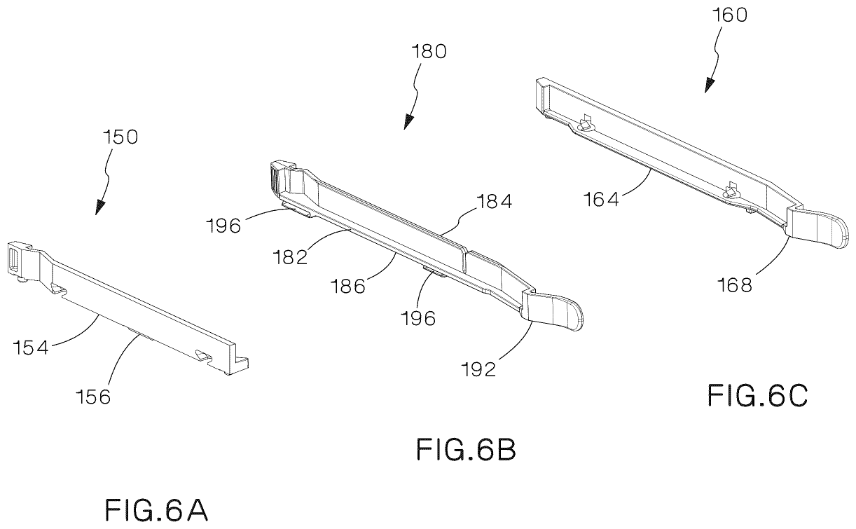

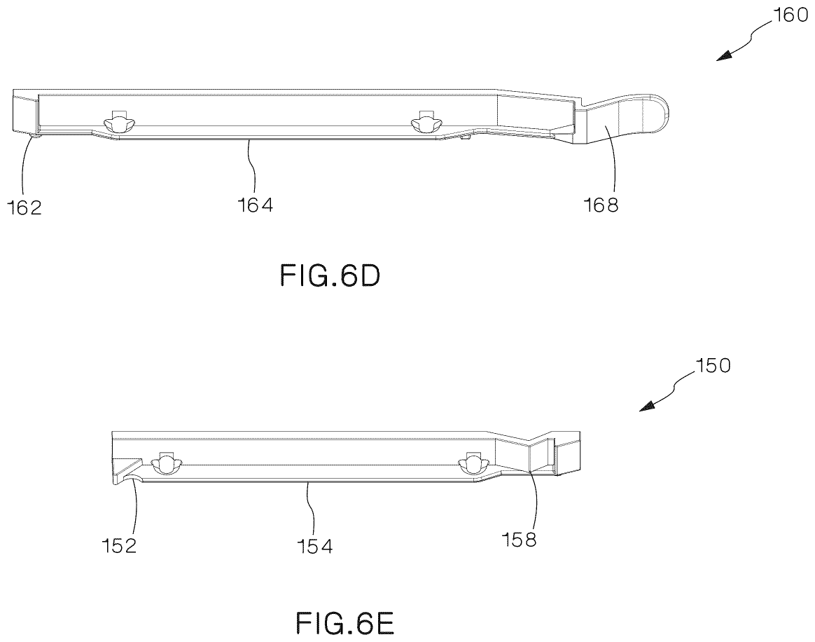

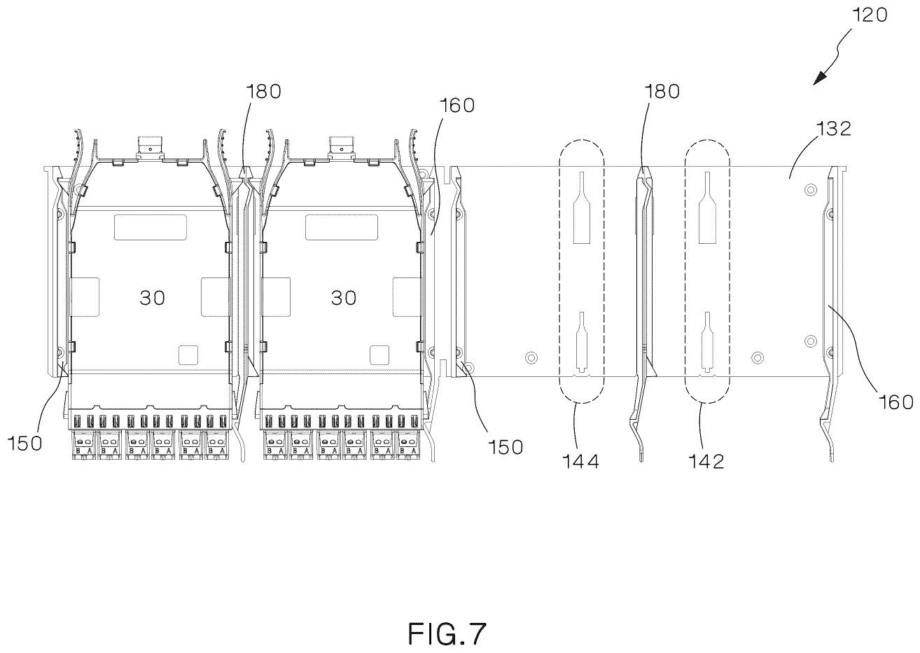

As shown in FIGS. 1A and 1B, a patch panel 50 consists of a frame 100, modular tray 120, and center support brackets 170. A plurality of removable rails 180 as shown in FIG. 6B may be added to or removed from the modular tray 120 in order to support differently-sized fiber optic modules 10 that support a different number of optical fibers. Referring to FIG. 5, in a preferred embodiment, the removable rails may be added or removed in order to support one 24-optical fiber module 20, two 12-optical fiber modules 30, or three 8-optical fiber modules 40. The fiber optic modules shown in all of the Figures (for example, FIG. 7) of this application include duplex LC adapters at the front of the module that lead to 1 MPO adapter at the rear of the module. The 24-optical fiber module 20 shown in the Figures includes 12 LC adapters; the 12-optical fiber module 30 as shown in the Figures includes 6 LC adapters; and the 8-optical fiber module 40 as shown in the Figures includes 4 LC adapters. One of ordinary skill in the art would understand that different numbers of optical fibers and different numbers and types of adapters may be used in a fiber optic module that may be installed within the present invention.

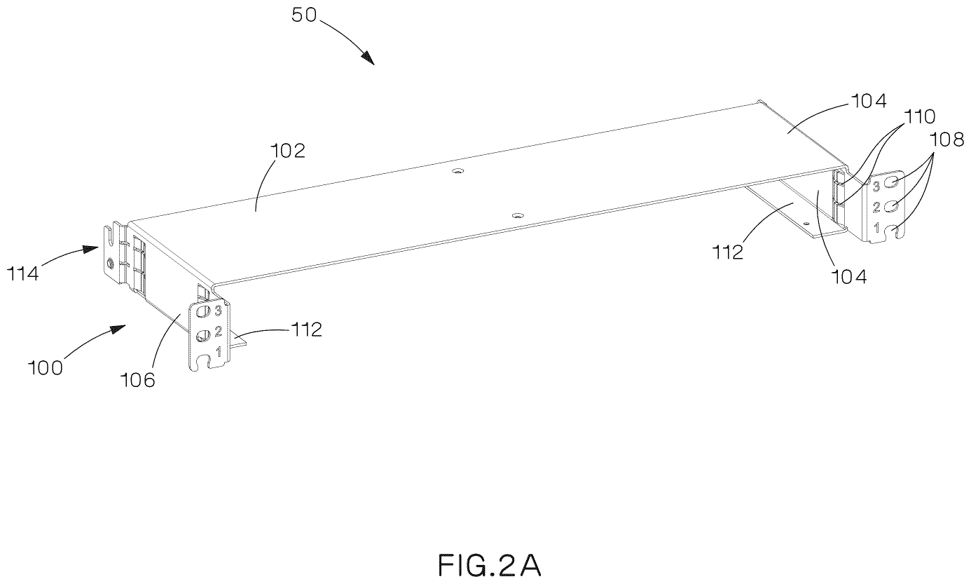

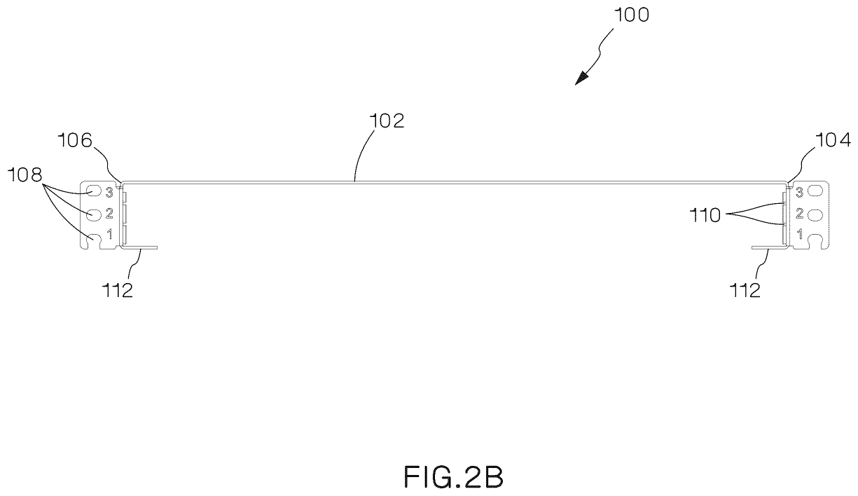

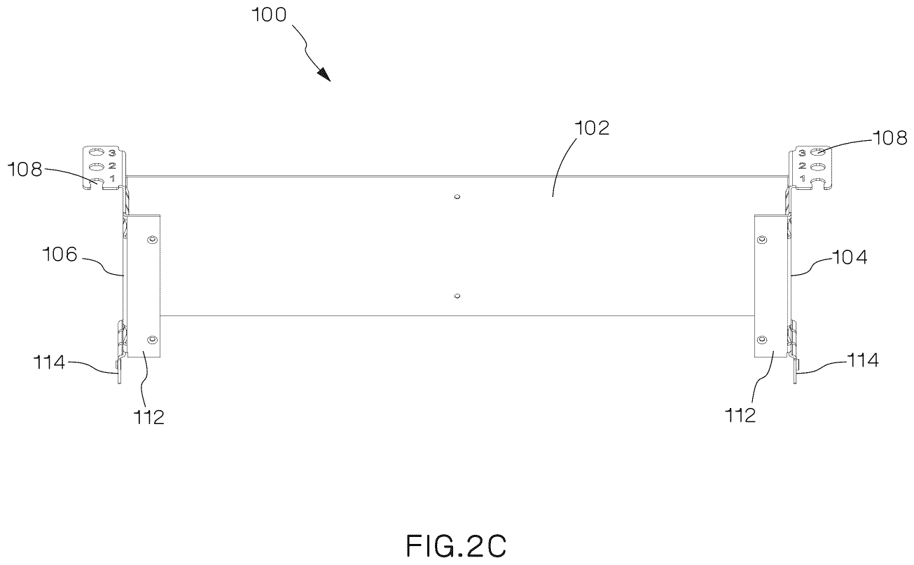

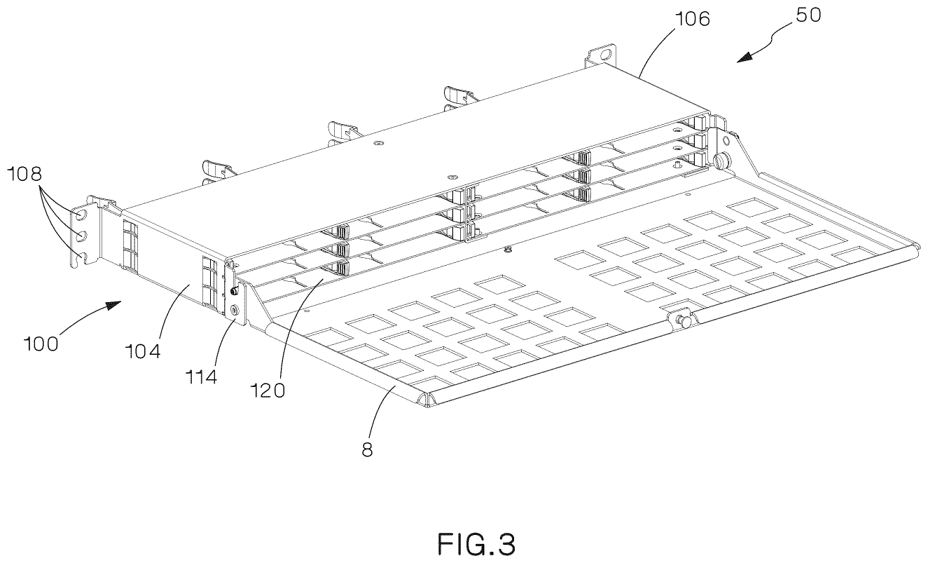

Referring now to FIGS. 2A, 2B, and 2C, the frame 100 includes a top cover 102, right side 104, left side 106, and a bottom flange 112. The bottom flange 112 is configured to support a modular tray 120. The right side 104 and left side 106 of the frame each include two bridge lance features 110 disposed above the bottom flange 112. The bridge lance features 110 are slots formed in the right side 104 and left side 106 of the frame 100 to support additional modular trays 120 in the frame 100. In a preferred embodiment, two bridge lance features 110 are disposed in each side so that the frame 100 can support two additional modular trays 120 above the modular tray 120 supported by the bottom flange 112. One of ordinary skill in the art would understand that the bridge lance features 110 and center support brackets 170 (described below) may have more or fewer slots that support modular trays 120. The frame may also include holes 108 for mounting the frame 100 to fiber optic enclosure rail 4 within a fiber optic enclosure 2 and mounts 114 for cable slack management trays 8 as shown in FIG. 3.

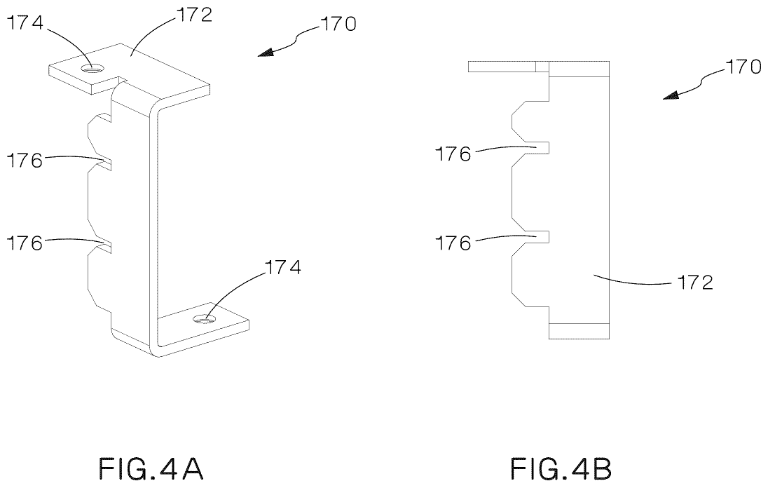

Referring now to FIGS. 4A and 4B, the center support brackets 170 are comprised of a bracket body 172, holes 174 to attach the bracket to the frame 100 and lowermost tray 120, and notches 176 to support the additional modular trays 120 disposed in the frame 100. In a preferred embodiment, the center support brackets 170 include two notches 176 to support two additional modular trays 120.

Referring now to FIG. 5, a modular tray 120 includes at least one tray body 132, at least one set of cutout features 140 disposed in the tray body 132, an alignment slot 134 located on the left edge 122 and right edge 124 of the tray body 132, a left rail 150 (see FIGS. 6A and 6E), and a right rail 160 (see FIGS. 6C and 6D). As shown in FIG. 5, two tray bodies 132 may make up one modular tray 120. The alignment slots 134 are each configured to receive an alignment feature 156, 166 located on the bottom portion 154 of the left rail 150 and bottom portion 164 of right rail 160. As shown in FIG. 6E, in addition to the alignment feature 156, the left rail 150 also includes a rear latch retention feature 152 and a fiber optic module contact protrusion 158. The rear latch retention feature 152 is configured to receive a rear fiber optic module retention latch 12 of a fiber optic module 10. The fiber optic module contact protrusion 158 is configured to abut against a fiber optic module 10 during installation of a fiber optic module 10 as well as once the fiber optic module 10 is installed. As shown in FIG. 6D, in addition to the alignment feature 166, the right rail also includes a rear latch retention feature 162 and a front stop latch 168. The front stop latch 168 is configured to retain a fiber optic module retention feature 12 when a fiber optic module 10 is fully installed in the modular tray 120. Both the left rail 150 and right rail 160 are riveted, secured with screws, or otherwise permanently installed onto the left edge 122 and right edge 124, respectively, of the modular tray body 132.

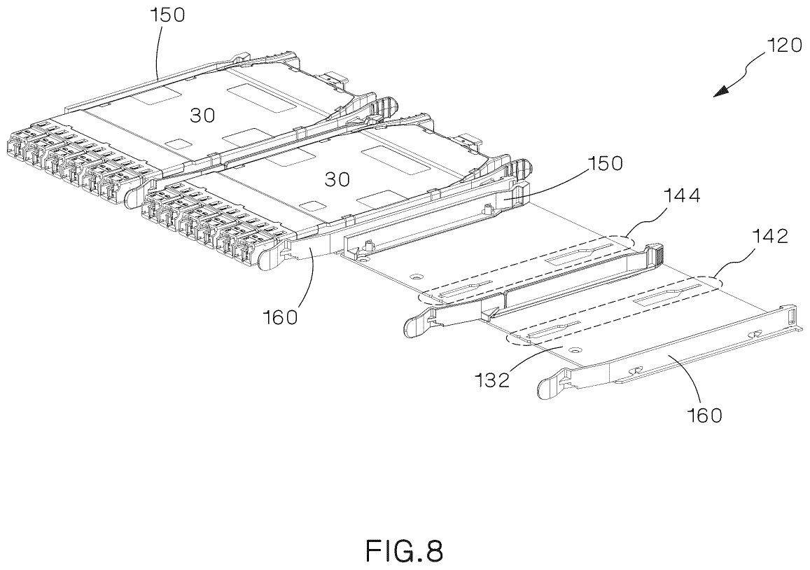

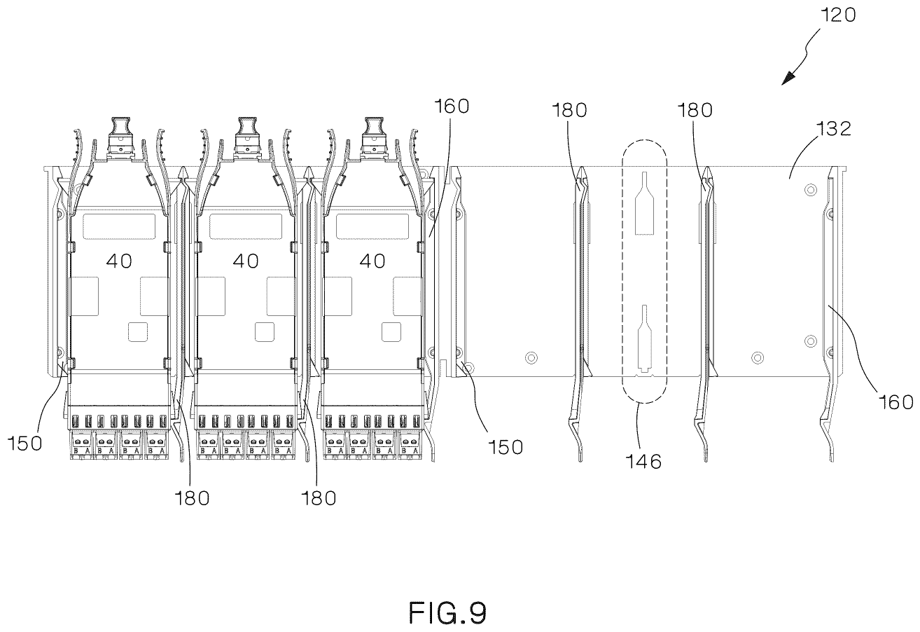

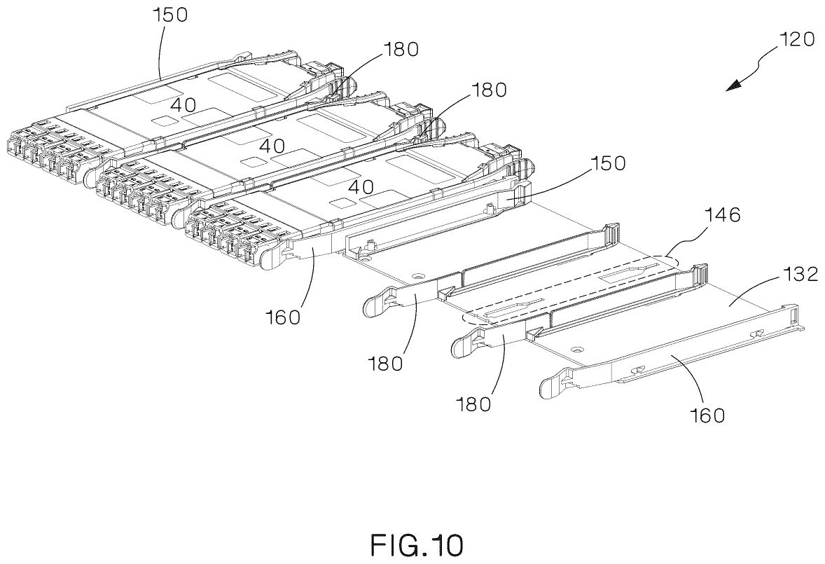

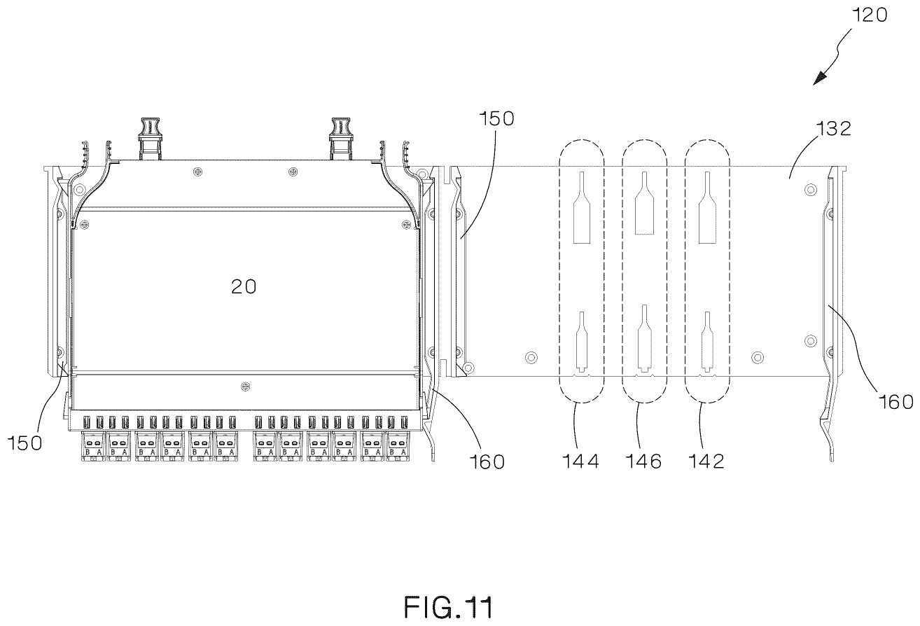

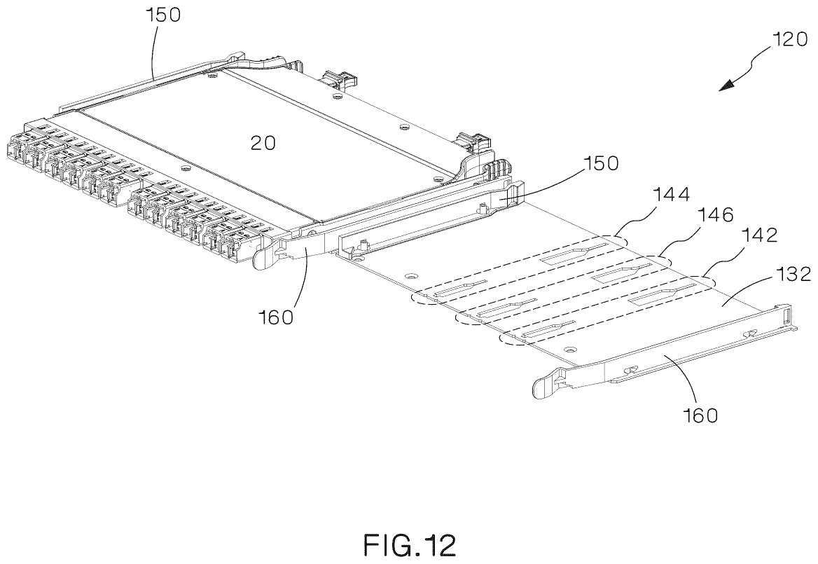

Referring back to FIG. 5, the cutout features 140 of the modular tray 120 are configured to receive a removable rail 180 in such a way that the removable rail 180 may be secured to and removed from the modular tray 120. In a preferred embodiment, one cutout feature 120 is a set of two or more cutouts in the body of the tray 120 each shaped to receive a portion of the removable rail 180. The cutout features 120 are preferably shaped as a larger rectangle at the portion of the cutout closest to the front of the modular tray 120 with a rear portion of the cutout that forms a slit. One set of cutout features 140 are disposed in a line parallel to the left and right rails 150, 160. Preferably, three sets of cutout features 140 are disposed on the modular tray. One middle set of cutout features 146 is disposed along the midline between the left and right rails 150, 160, so that, when a removable rail 180 is installed within the middle set of cutout features 146, two 12-optical fiber modules 30 may be installed on either side of the removable rail 180 as shown in FIGS. 7-8. Two additional sets of cutout features, left set of cutout features 144 and right set of cutout features 142, are disposed on either side of the middle set of cutout features 146 so that, when removable rails 180 are installed in both the left set of cutout features 144 and right set of cut out features 142, three 8-optical fiber modules 40 may be installed into the modular tray 120 as shown in FIGS. 9-10. Finally, when no removable rails 180 are installed in the modular tray 120, one 24-optical fiber module may be installed between the left rail 150 and right rail 160 as shown in FIGS. 11-12.

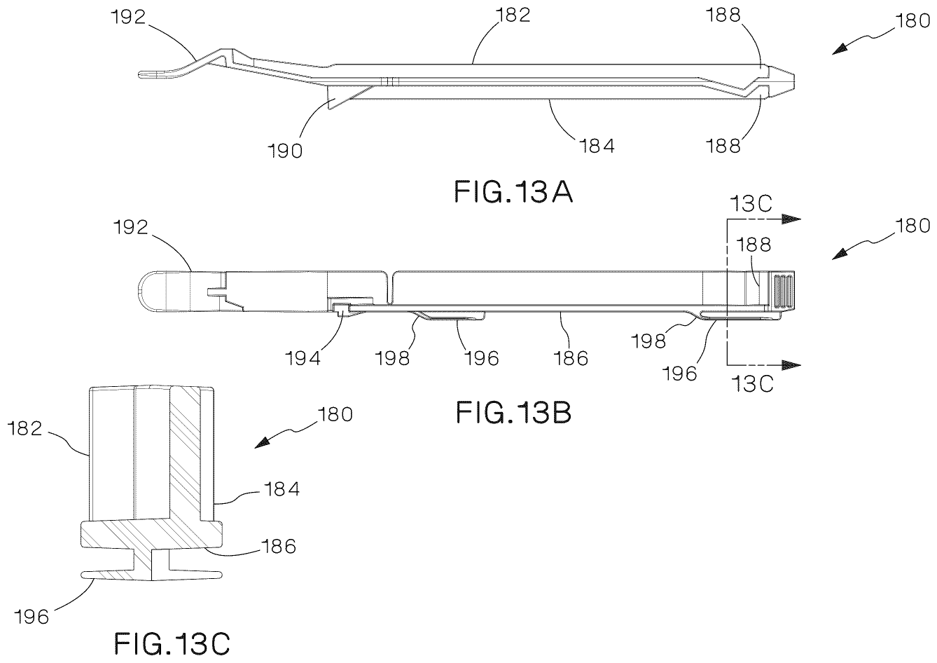

Referring now to FIGS. 13A, 13B, and 13C, the removable rails 180 include two rear latch retention features 188, a module contact protrusion 190, a front stop latch 192, a front retention boss 194, and at least one T-shaped mounting feature 196. One rear latch retention feature 188 is disposed on the left side 182 and right side 184 of the removable rail 180. The rear latch retention features 188, module contact protrusion 190, and front stop latch 192 are the same as on the left rail 150 and right rail 160. The front retention boss 194 is disposed within the front-most portion of the front-most cutout feature 140a when the removable rail 180 is fully installed in a modular tray 120. The T-shaped mounting feature 196 is located on the bottom of the removable rail 180 and includes a tapered front portion 198. The T-shaped mounting feature is shaped so that it can be inserted into the larger rectangle portion of the cutout features 140 closest to the front of the modular tray 120 and then slid toward the back of modular tray 120 so that the T-shaped mounting feature 196 securely engages with the rear portion of the cutout features 140 that forms a slit.

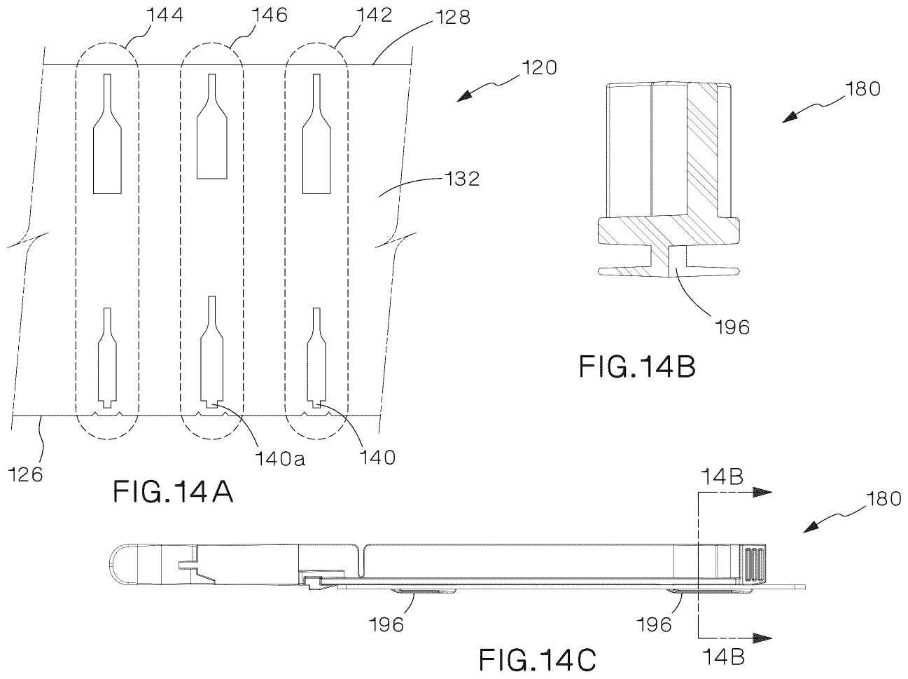

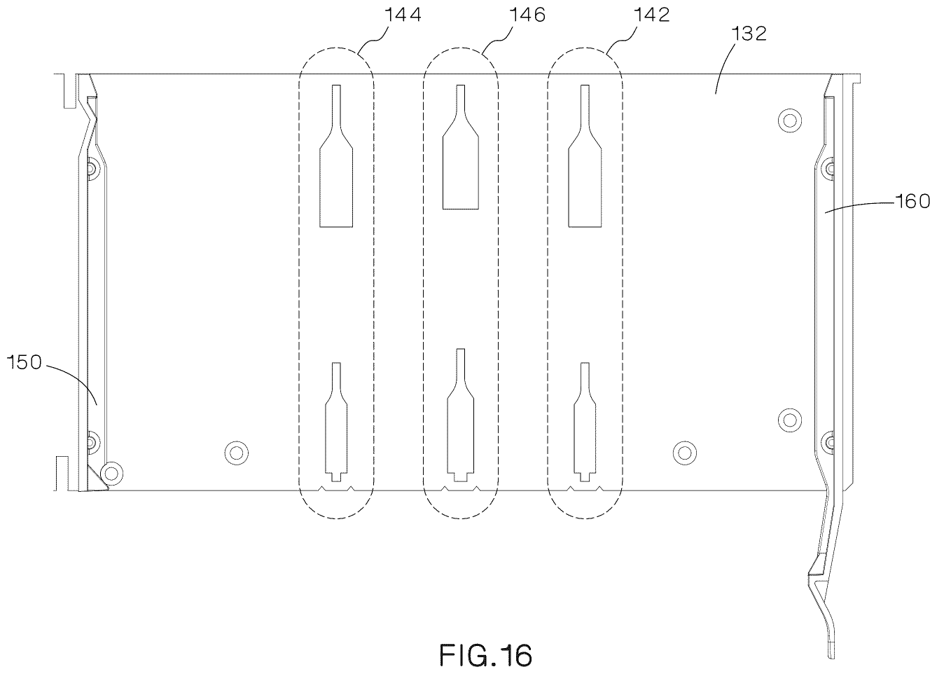

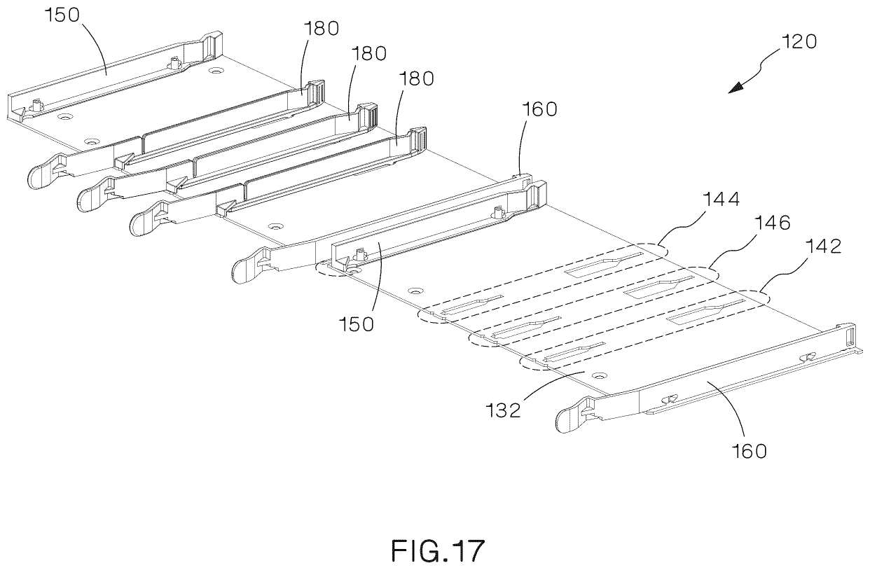

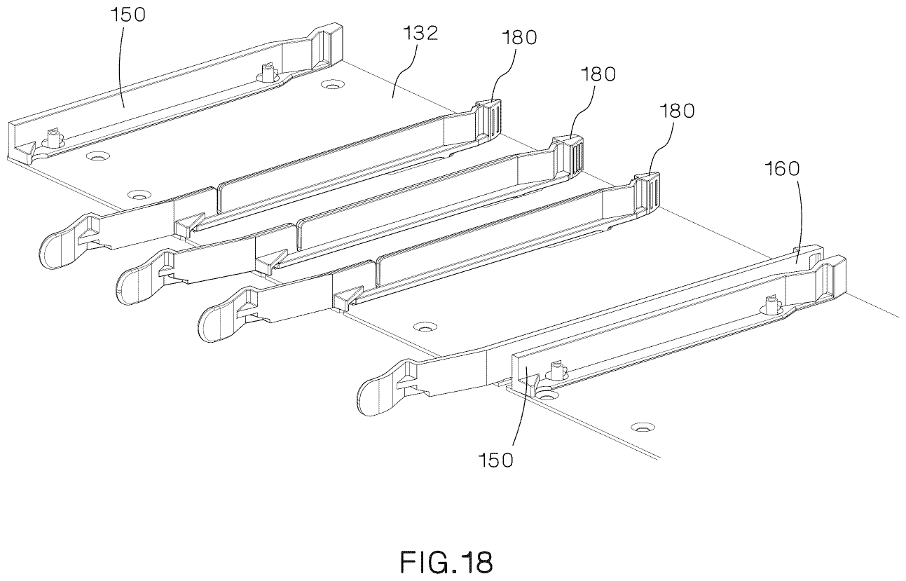

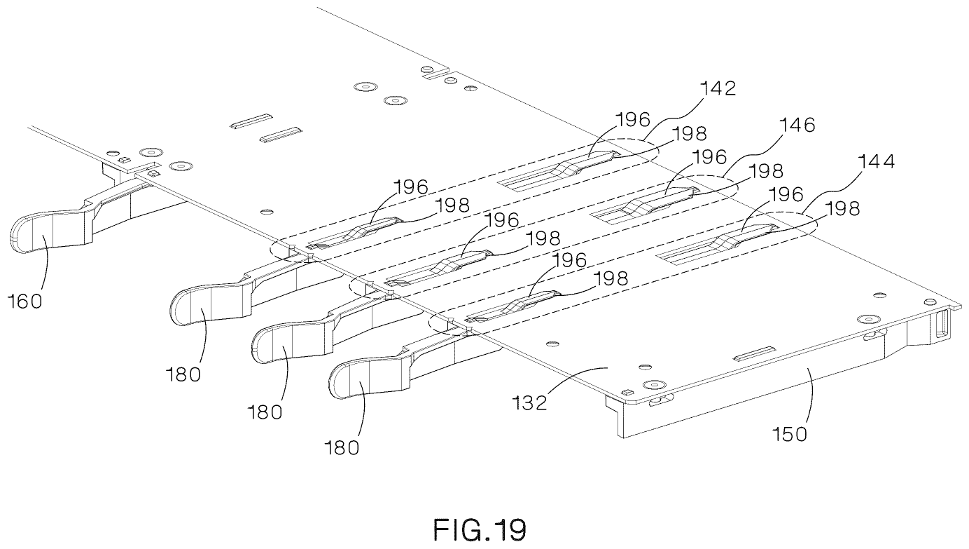

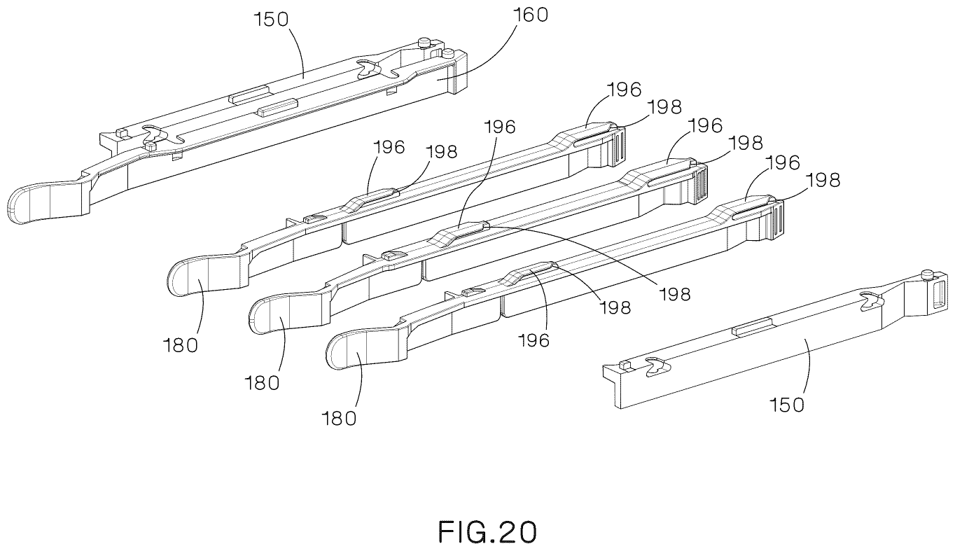

As shown in FIGS. 14-24, if different sets of cutout features 140 are disposed on the tray 120, one or more of the sets may be slightly different—i.e., as shown in FIGS. 17-19, the cutout features may be of different sizes or shapes or may be closer or further away from the front of the tray 120 than cutout features in other sets of cutout features. If this is the case, the removable rails 180 configured to be disposed in the cutout features would also be slightly different so that only a removable rail 180 designed to be installed in a particular set of cutout features 140 could be installed in that set of cutout features 140. Such different sizes or shapes may allow for different rails to be used in different positions. Additionally, these rails of different sizes or shapes may be color coded or otherwise identified to match up the appropriate removable rail 180 to a set of cutout features 140.

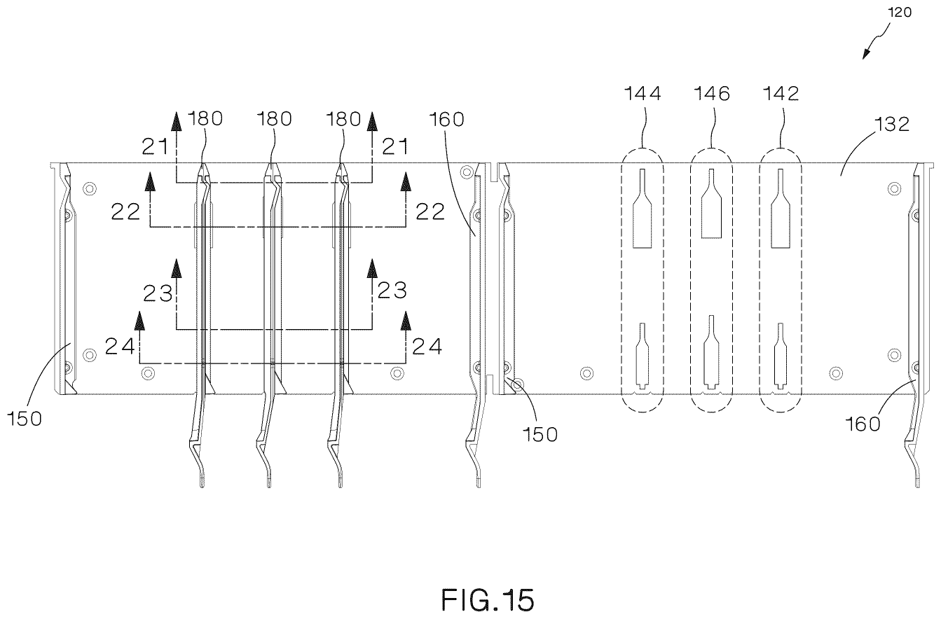

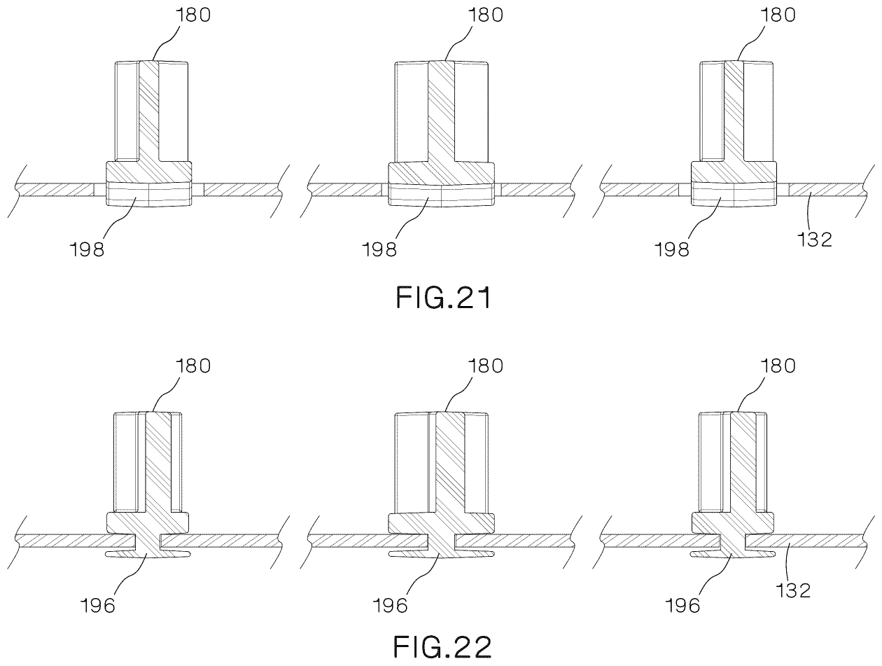

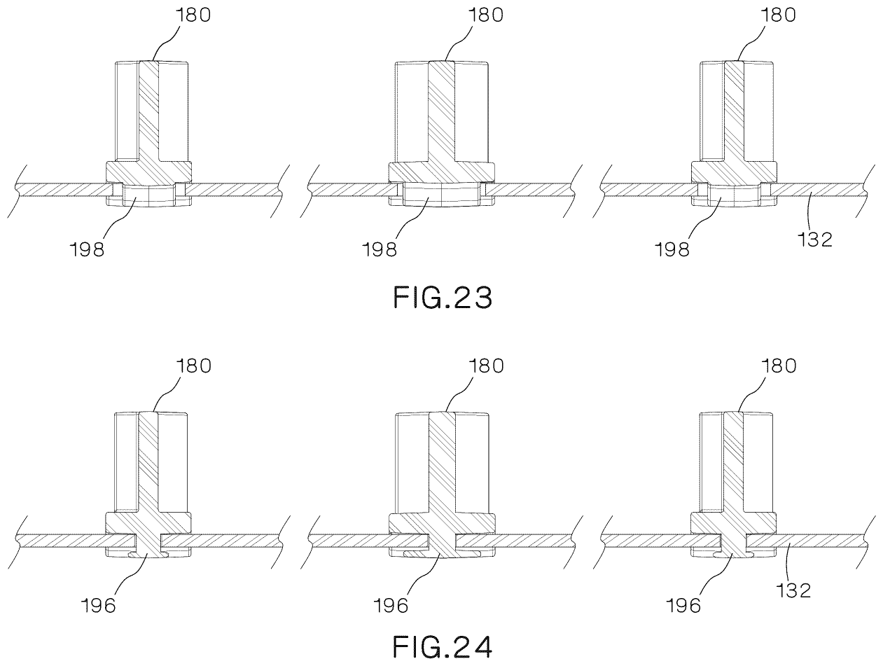

FIGS. 21-24 provide cross-sectional views of the removable rails 180 installed in the modular tray 120 shown in FIG. 15. As can be seen in FIG. 21, the tapered front of the T-shaped mounting feature 198 at the rear of the center removable rail 180 is larger than the outside removable rails 180. Similarly, as shown in FIG. 22, the cross-section of the center removable rail 180 is larger than the cross-section of the outside removable rails 180. Thus, the center removable rail 180 would only fit within the middle set of cutout features 146, and the outside removable rails 180 would only fit within the left and right sets of cutout features 142, 144. FIGS. 23 and 24 show that the second T-shaped features of the removable rails 180 have similarly-sized cross sections—i.e., the tapered front 198 and cross section of the T-shaped mounting features 196 of the center removable rail 180 are larger than the tapered front 198 and cross section of the T-shaped mounting features 196 of the outside removable rails 180. One of ordinary skill in the art would understand that this feature may be accomplished in many other ways—for example, the middle set of cutouts 146 and T-shaped mounting feature 196 of the middle removable rail 180 may be disposed slightly closer to the front if the modular tray 120 than the left and right sets of cutouts 242, 244 and the T-shaped mounting features 196 of the left and right removable rails 180.

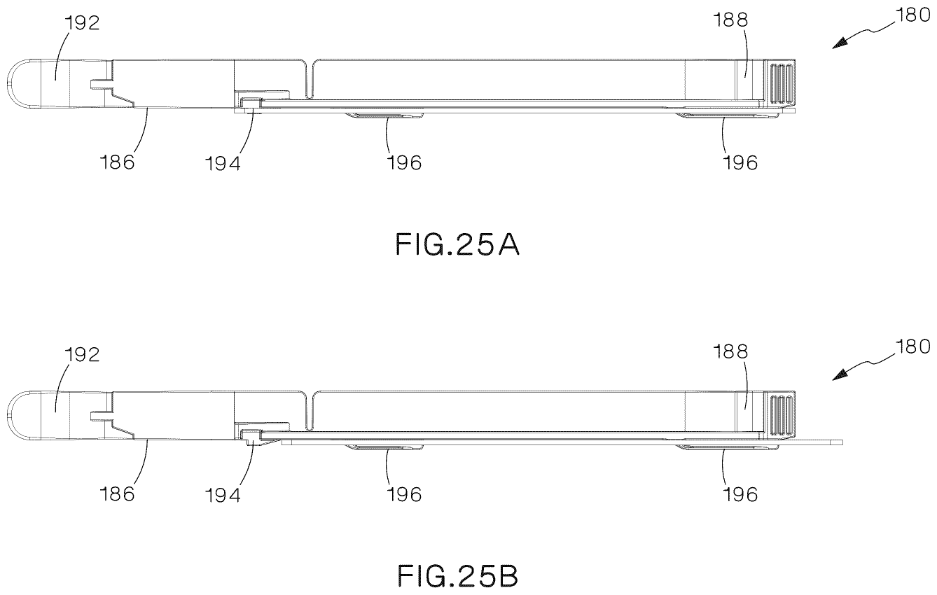

As shown in FIGS. 25A and 25B, in which the removable rail 180 is fully installed in FIG. 25A, in order to install a removable rail 180 into a modular tray 120, the T-shaped mounting feature(s) 196 of the removable rail 180 are inserted through the larger portion of the cutout features 140 in one set of cutout features. The removable rail 180 is then slid toward the back of the modular tray 120 until the T-shaped mounting feature 196 is secured within the narrower portion of the cutout features 140. When the T-shaped mounting features 196 reach the rear-most portion of the cutout features 140, the front retention boss 194 slides into and abuts the front of the front-most cutout 140a. Thus, the front retention boss 194 secures the removable rail 180 in the modular tray 120. In order to remove the removable rail 180, a user first uses his hand or other tool to press the front retention boss 194 upward past the front of the front-most cutout 140a. Once the front retention boss 194 clears the front-most cutout 140a, the removable rail 180 may be slid toward the front of the modular tray 120 until the T-shaped features 196 of the removable rail 180 are located in the larger portion of the cutout features 140. The removable rail 180 is then no longer secured to the modular tray 120 and may be removed.

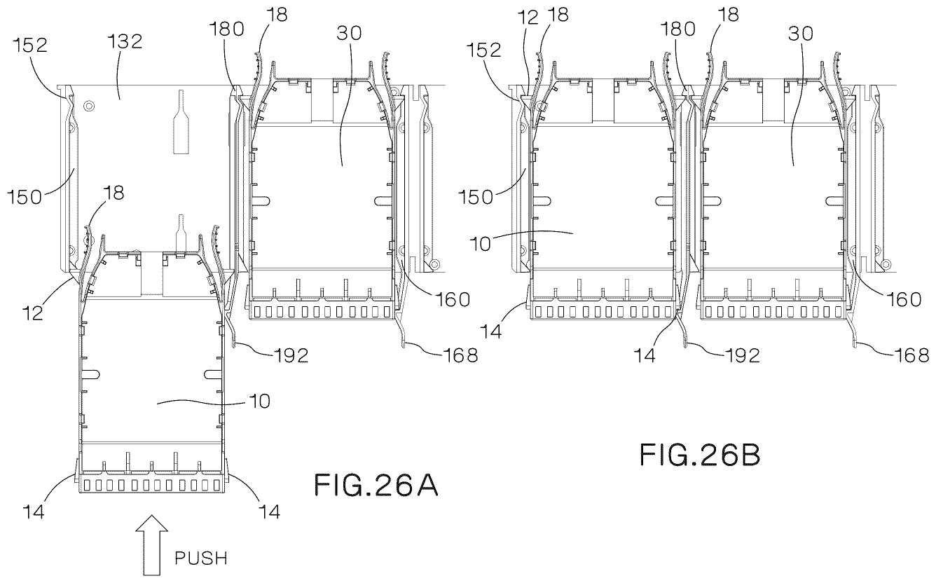

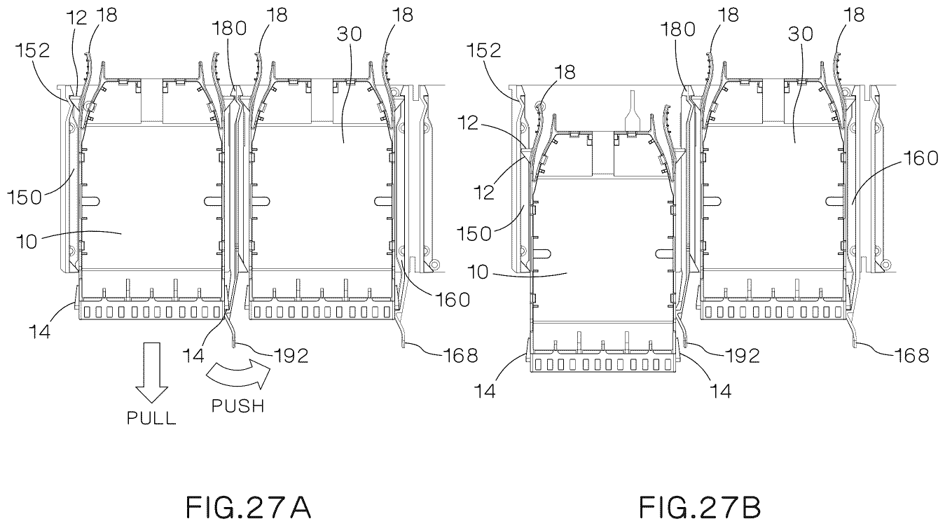

As shown in FIGS. 26A and 26B, once the removable rail 180 is installed, fiber optic modules 10 may be installed onto the tray 120 in a conventional manner. In particular, to install a fiber optic module 10 from the front of the fiber optic enclosure 2, a user pushes the fiber optic module 10 from the front of the enclosure into a space on the tray formed by two of the rails installed on the modular tray 120. The user continues pushing the fiber optic module 10 into the space until the front retention feature 14 of the fiber optic module 10 seats within a front stop latch 168 or 192. As shown in FIGS. 27A and 27B, to uninstall a fiber optic module 10 from the front of the enclosure 2 a user pushes the front stop latch 168 or 192 to the right to release the fiber optic module 10. The user then pulls the fiber optic module 10 toward the front of the fiber optic enclosure 2.

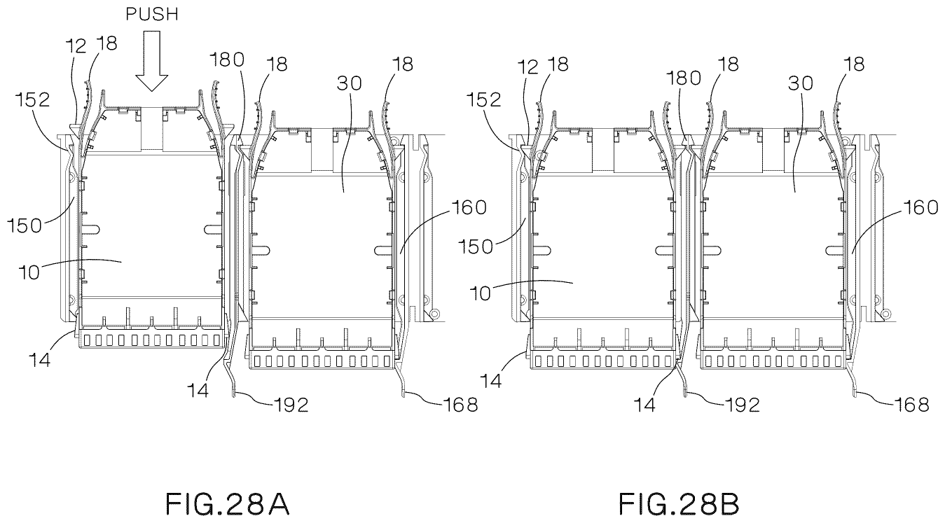

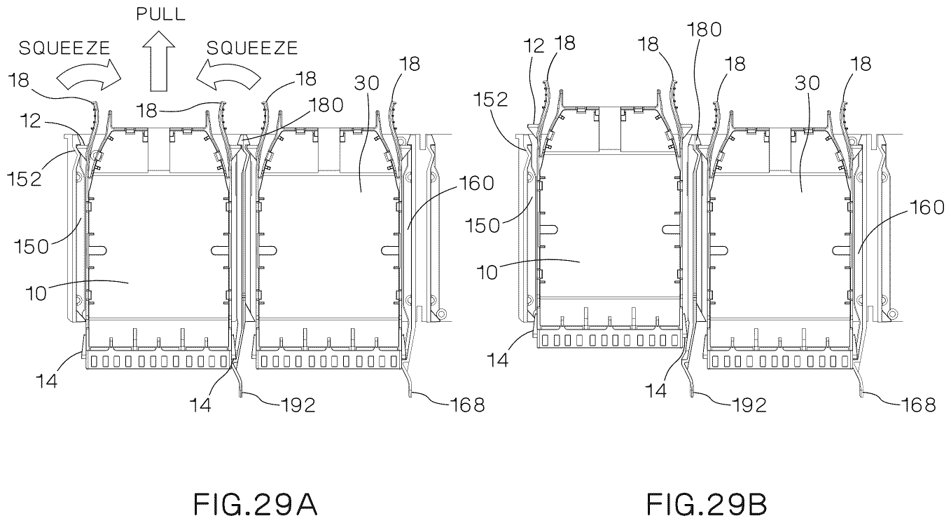

Referring now to FIGS. 28A and 28B, to install a fiber optic module 10 from the rear of the fiber optic enclosure 2, the user pushes the fiber optic module 10 from the rear of the enclosure 2 into a space on the tray 120 formed by two of the rails installed on the modular tray 120. The user continues pushing until the rear module retention latches 12 of the fiber optic module 10 seat in the rear latch retention features 152, 162, or 188 of the rails. As shown in FIGS. 29A and 29B, to uninstall a fiber optic module 10, a user squeezes the rear module retention latches 12 of the module toward each other until the fiber optic module 10 is released from the rear latch retention features 152, 162, or 188. The user then continues to pull the fiber optic module 10 toward the rear of the fiber optic enclosure 2.

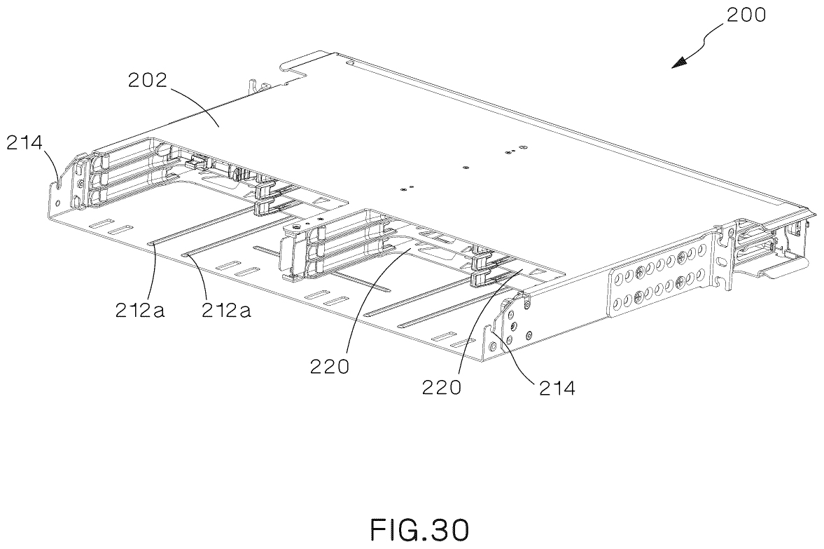

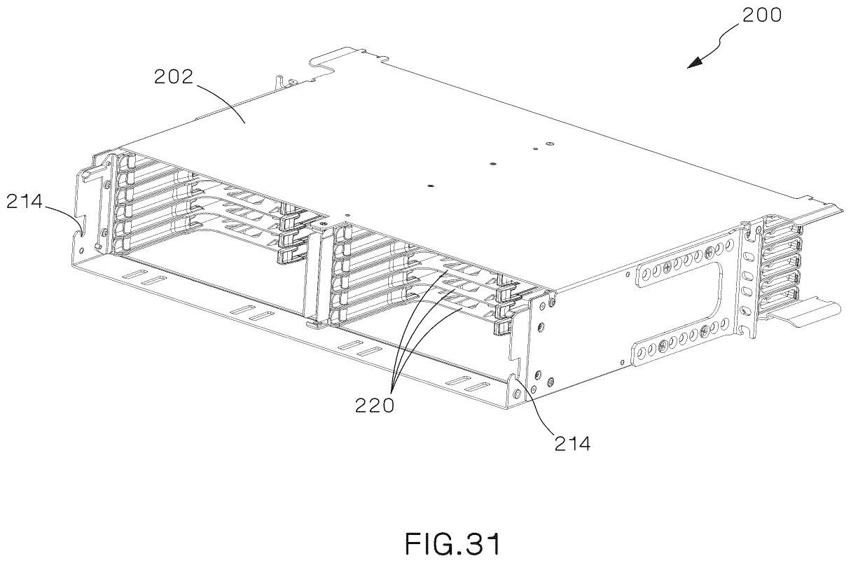

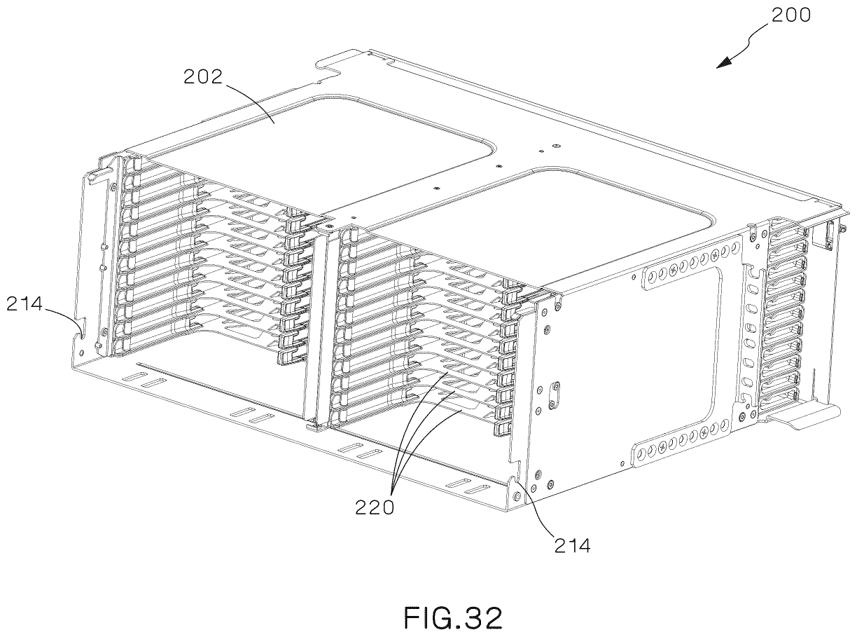

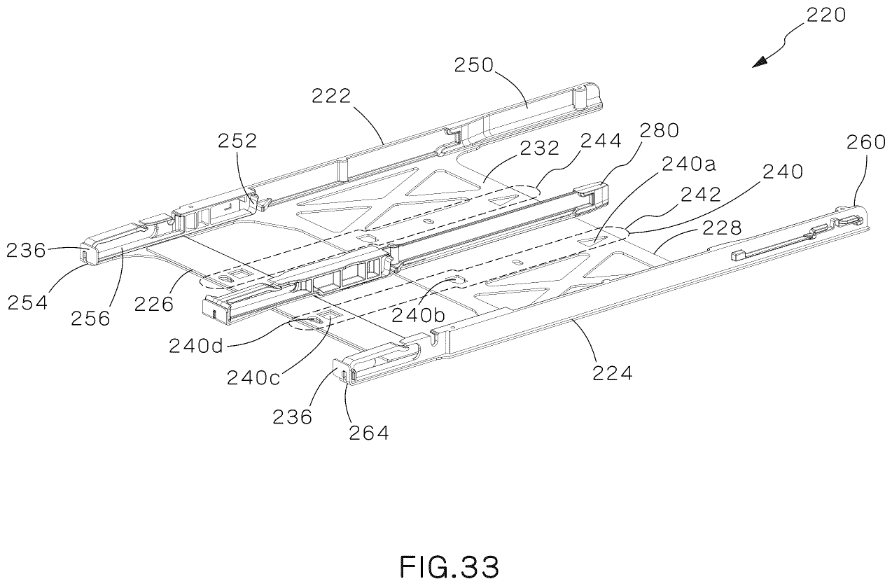

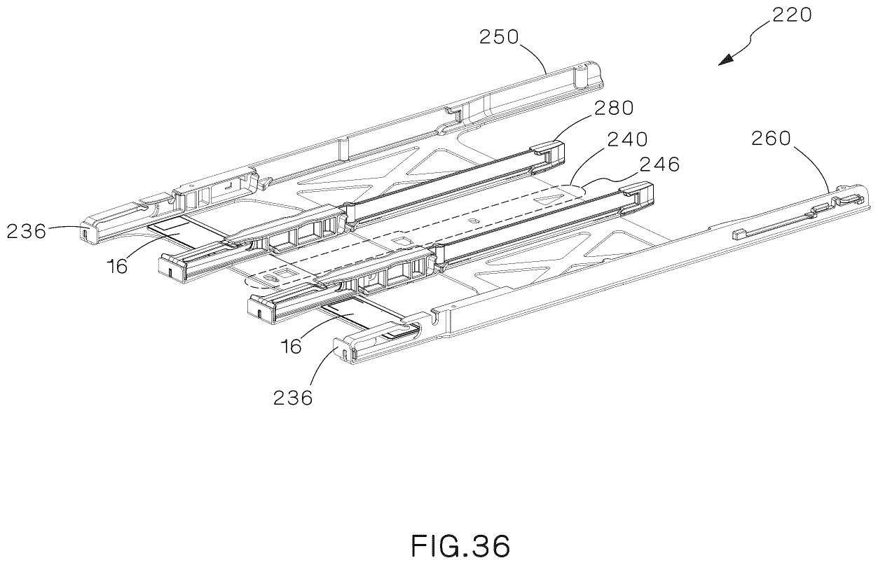

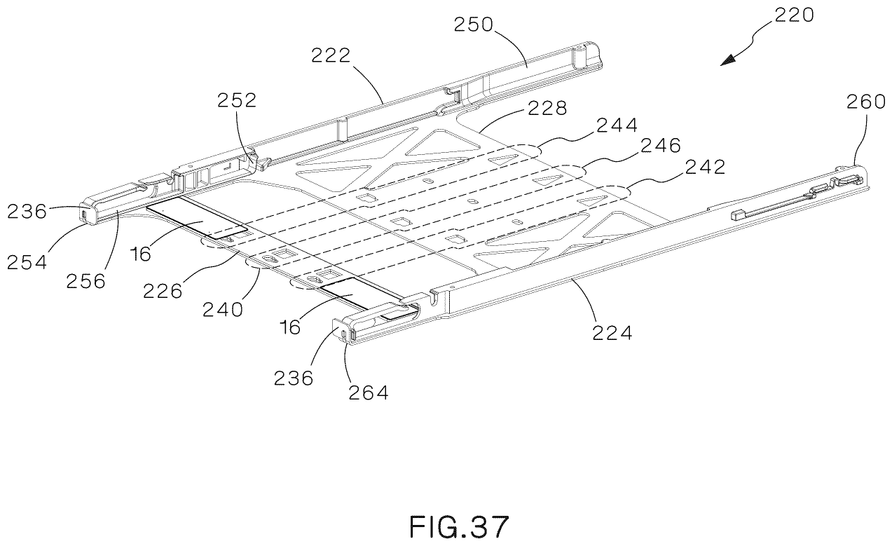

Another embodiment of the present invention, a High Density Fiber Enclosure (HDFE) 200 that includes a modular tray and removable rail design is described below. As shown in FIGS. 30-32, the High Density Fiber Enclosure 200 includes a top cover 202, bottom portion 212, and mounting for cable slack management 214. As further shown in FIG. 33, the HDFE 200 also includes a HDFE modular tray 220 that includes at least one tray body 232, HDFE cut out features 240, alignment pins 234, alignment holes 230, metal tabs 236, a HDFE left rail 250, a HDFE right rail 260, and two labels 16 (shown in FIGS. 36-37). One alignment pin 234 each is located on the left edge 222 and right edge 224 of the HDFE modular tray 220 and passes through an alignment hole 230. The alignment pins 234 are self-clinching and are configured to engage with a hole in a HDFE left rail 250 and right rail 260, respectively, to align the HDFE left rail 250 and right rail 260 with the left edge 222 and right edge 224 of the HDFE modular tray 220. The alignment pins 234 may be self-tapping screws or another suitable fastener known in the art. A metal tab 236 is located at the front-most portion of the left edge 222 and right edge 224 of the HDFE modular tray 220. The metal tab 236 extends upward at a 90-degree angle to the HDFE modular tray 220 and secures the front portion of the HDFE left rail 250 and right rail 260. The labels 16 are disposed on the front 226 of the HDFE tray 220.

The HDFE left rail 250 and HDFE right rail 260 are both permanently secured to the left edge 222 and right edge 224 respectively of the HDFE modular tray 220. The HDFE left rail 250 and HDFE right rail 260 also both include a metal spring clip 252, 262 for retaining a fiber optic module 10. The metal spring clip 252 is disposed on the right side 256 of the HDFE left rail 250, and the metal spring clip 262 is disposed on the left side 266 of the HDFE right rail 260 so that the metal spring clips 252, 262 face one another.

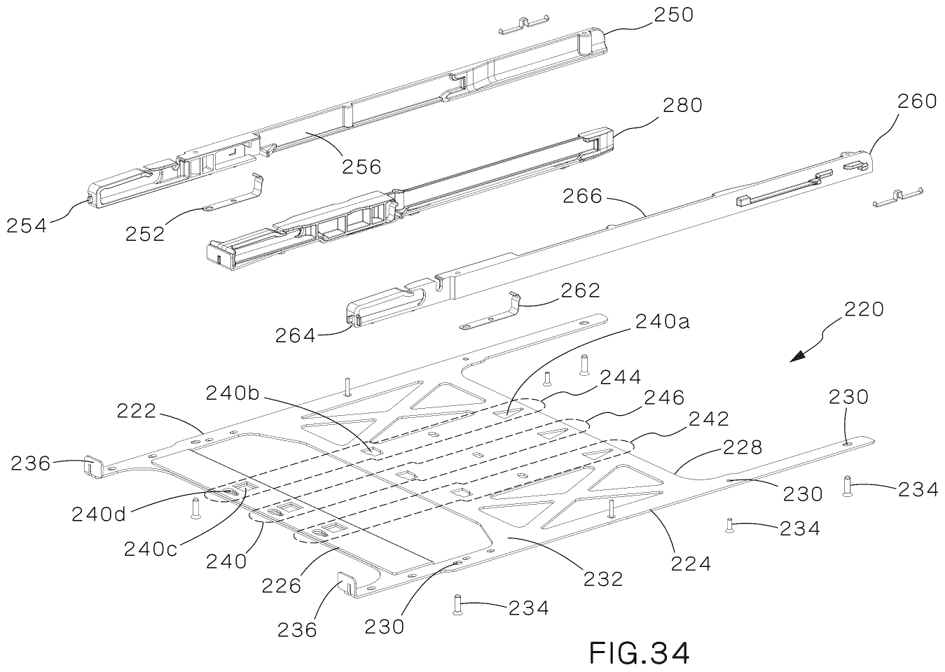

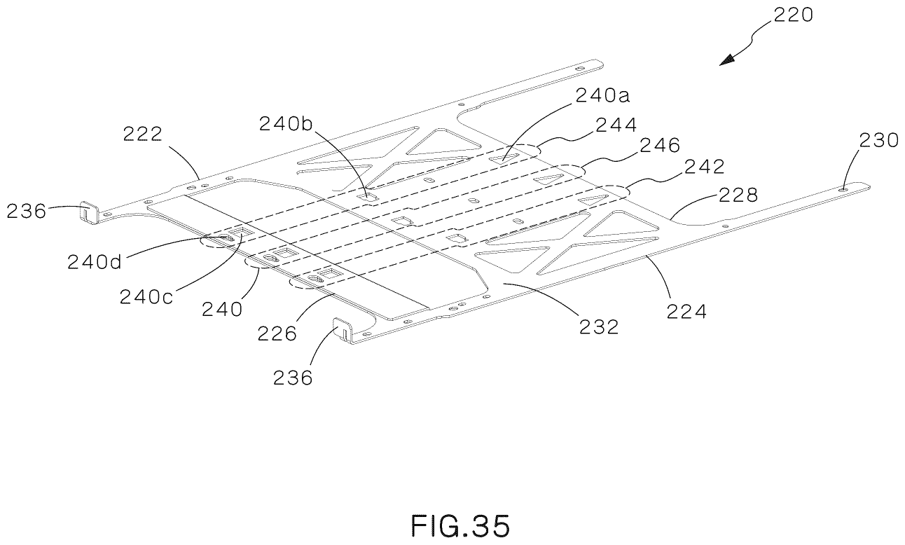

The HDFE cutout features 240 are formed to removably receive HDFE removable rails 280. As shown in FIGS. 33-37, a HDFE cutout feature 240 is a set of two or more cutouts in the body of the tray 220 each shaped to receive a portion of the HDFE removable rail 280. The set of cutout features 240 are disposed in a line parallel to the left and right rails 250, 260. In a preferred embodiment four cutouts comprise one set of cutout features 240. The rear-most cutout 240a is triangularly-shaped so that the triangle points toward the rear 228 of the HDFE modular tray 220. The middle cutout 240b is formed of an overlapping larger and smaller rectangle, where the smaller rectangle is configured to securely hold a portion of the HDFE removable rail 280. The final two cutouts are disposed proximate to one another near the front 226 of the HDFE modular tray 220. The forward-most cutout 240d is formed of two ovals cut out of the HDFE modular tray 220. One of the ovals is larger than the other, and the ovals overlap so that a self-clinching keyhole fastener 284 of a removable rail 280 may be inserted into the larger oval portion of the forward-most cutout 240d and then slid over to be secured in the smaller oval portion of the forward-most cutout 240d. The final cutout, the latch-receiving cutout 240c, is located just to the rear of the forward-most cutout 240d and is configured to receive a latch 290c located on the HDFE removable rail 280. One embodiment of the latch-receiving cutout 240c is a rectangular-shaped cutout.

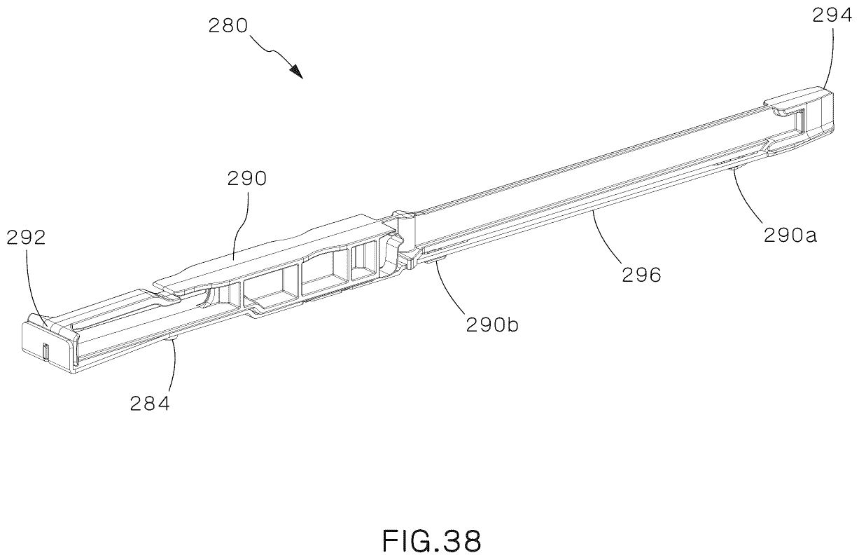

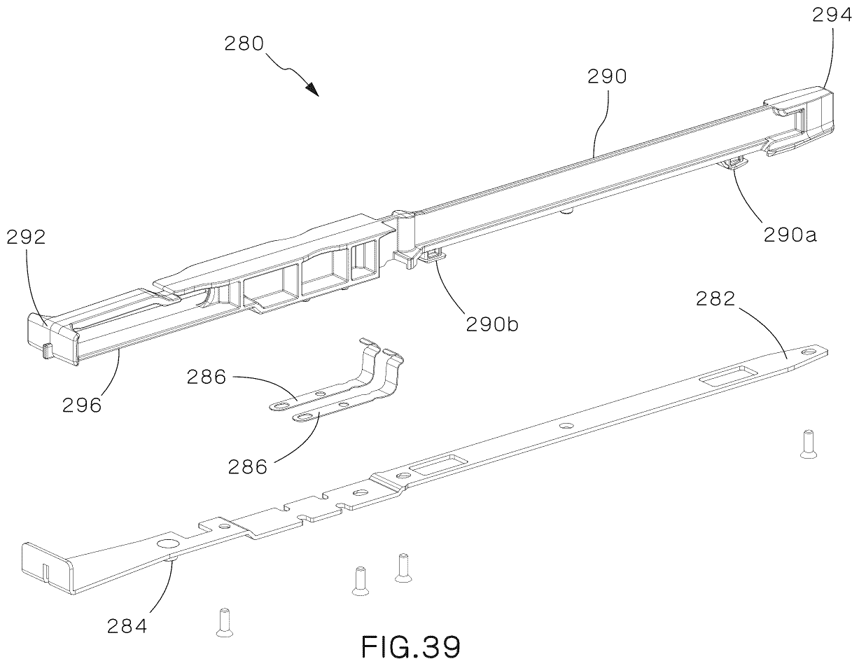

Referring now to FIGS. 38 and 39, the HDFE removable rail 280 includes a metal bracket 282, two metal spring clips 286, a cassette guide 290, and protrusions for engaging with the cutout features on the HDFE modular tray 220. The metal bracket 282 extends along the bottom portion 296 of the cassette guide 290 and includes a self-clinching keyhole fastener 284 for engaging with the forward-most cutout 240d of the HDFE modular tray 220. The two metal spring clips 286 are disposed on either side of the HDFE removable rail 280. The cassette guide 290 is disposed on top of the metal bracket 282 and includes several protrusions for engaging with the cutout features on the HDFE modular tray 220 as described below. One of ordinary skill in the art would understand, and it is contemplated by this invention, that the HDFE removable rail 280 could also be formed of just one piece and/or could be made of one material. Moreover, HDFE removable rail 280 could be color-coded for easy identification by a user.

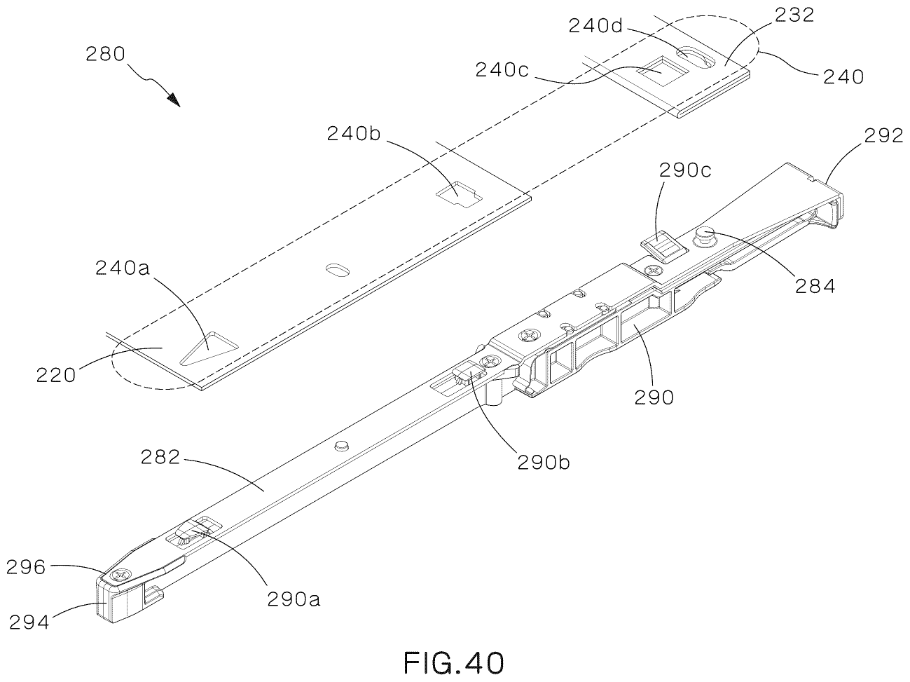

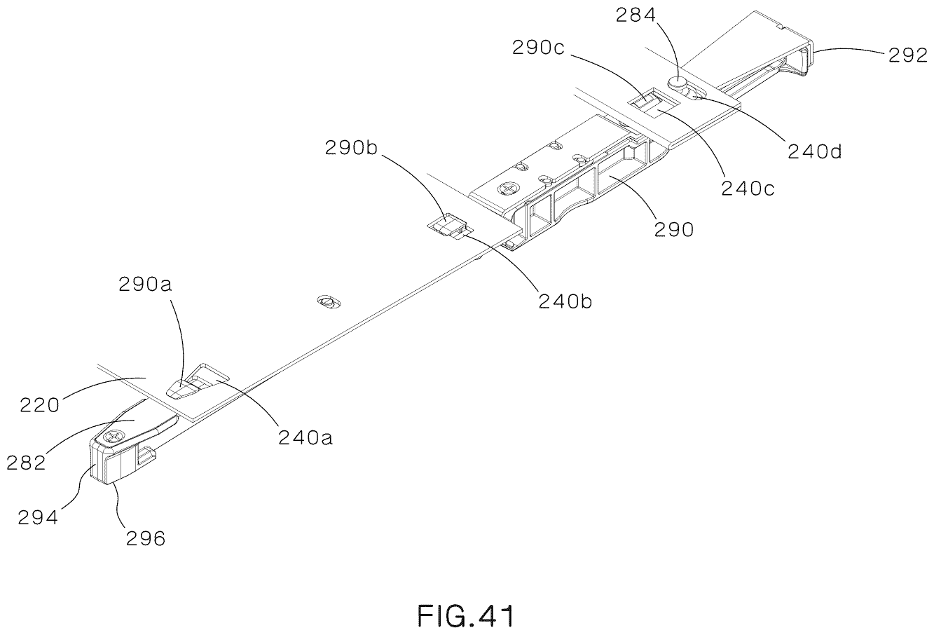

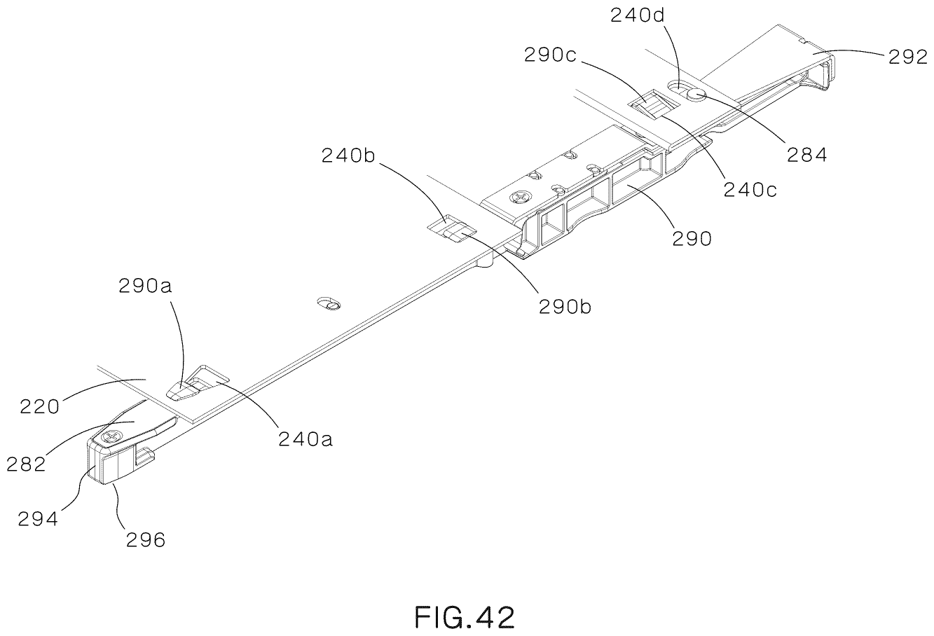

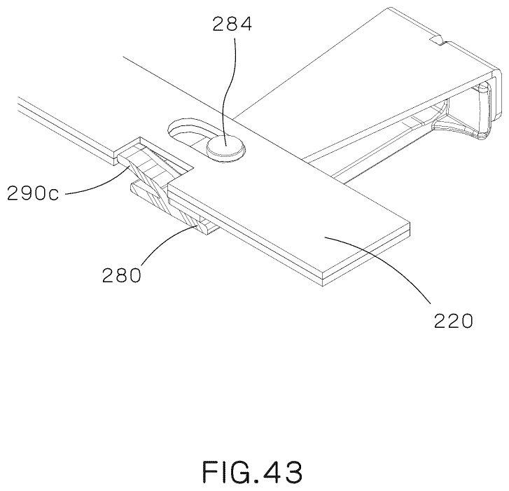

As shown in FIGS. 40-43, the protrusions for engaging with the cutout features on the HDFE modular tray 220 include a front latch 290c, a middle protrusion 290b, and a rear protrusion 290a. The front latch 290c includes a latching portion which extends in the direction of the HDFE modular tray 220 when the HDFE removable rail 280 is installed in the HDFE tray 220 so that the HDFE removable rail 280 may not be moved side to side upon the HDFE removable tray 220. The front latch 290c is disposed on the front portion 292 of the cassette guide 290. The latching portion of the front latch 290c extends into the latch-receiving cutout 240c to lock the HDFE removable rail 280 to the HDFE modular tray 220. The middle protrusion 290b is formed to engage with the middle cutout 240b and disposed between the front 292 and rear 294 portions of the cassette guide 290. The middle protrusion 290b is preferably T or I-shaped so that the top of the T or I of the middle protrusion 290b is disposed through the middle cutout 240b when the HDFE removable rail 280 is installed in the HDFE modular tray 220. The rear protrusion 290a is formed to engage with the rear-most cutout 240a and disposed on the rear 294 of the cassette guide 290. The rear protrusion 290a is formed so that the rear portion of rear protrusion 290a engages with the triangularly-shaped rear-most cutout 240a so that the HDFE removable rail 280 can pivot in a plane parallel to the HDFE modular tray 220.

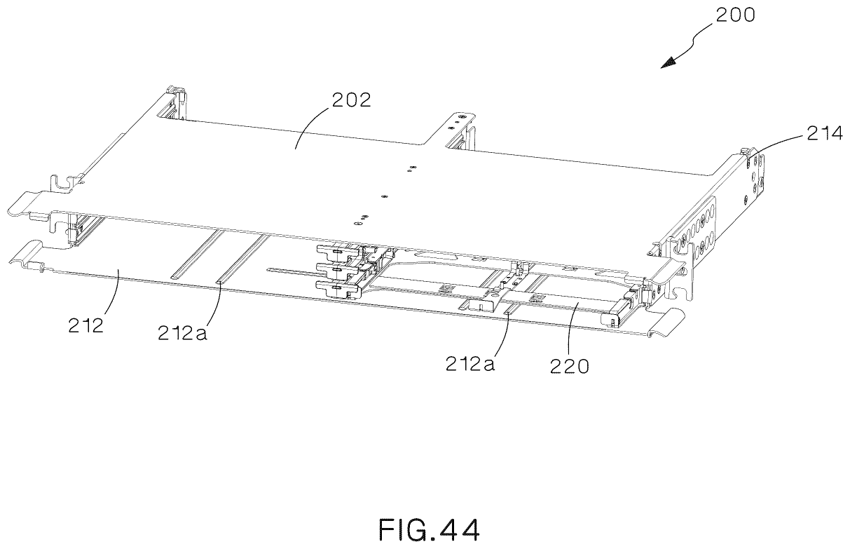

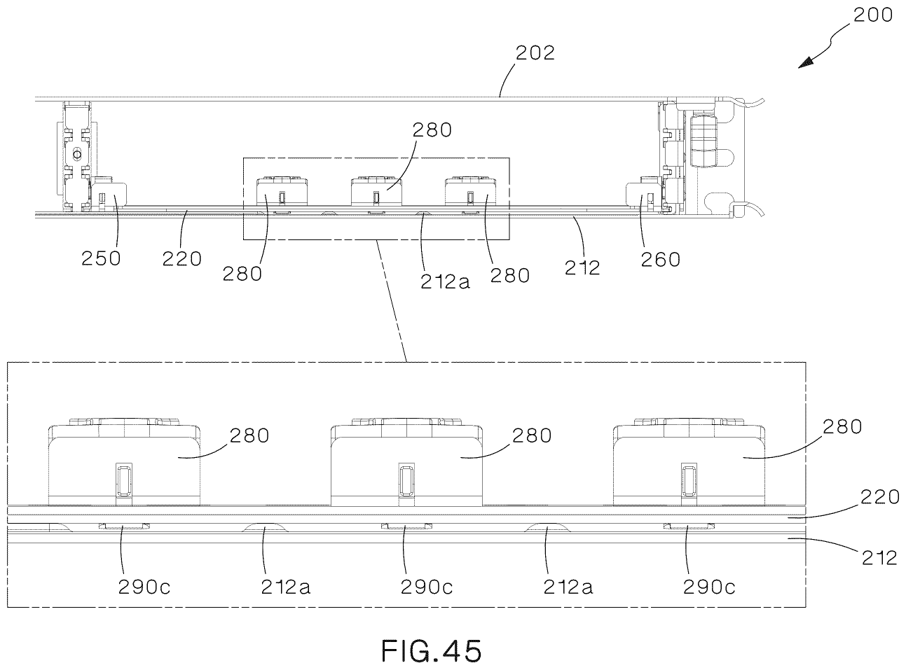

As shown in FIGS. 44-46, portions of the bottom portion 212 of the HDFE enclosure 200 may be raised. One of ordinary skill in the art would understand that these raised or beaded portions are typically included in an enclosure to strengthen the enclosure. However, the beads 212a that run parallel to the rails 250, 260, and 280 also provide clearance between the HDFE tray 220 and the bottom portion 212 of the HDFE enclosure 200. This provides a space for the protrusions 290a, 290b, and 290c of the HDFE removable rail 280 to move within when a HDFE removable rail 280 is installed within an HDFE tray 220. Other shapes and types of beads 212a are contemplated by this disclosure.

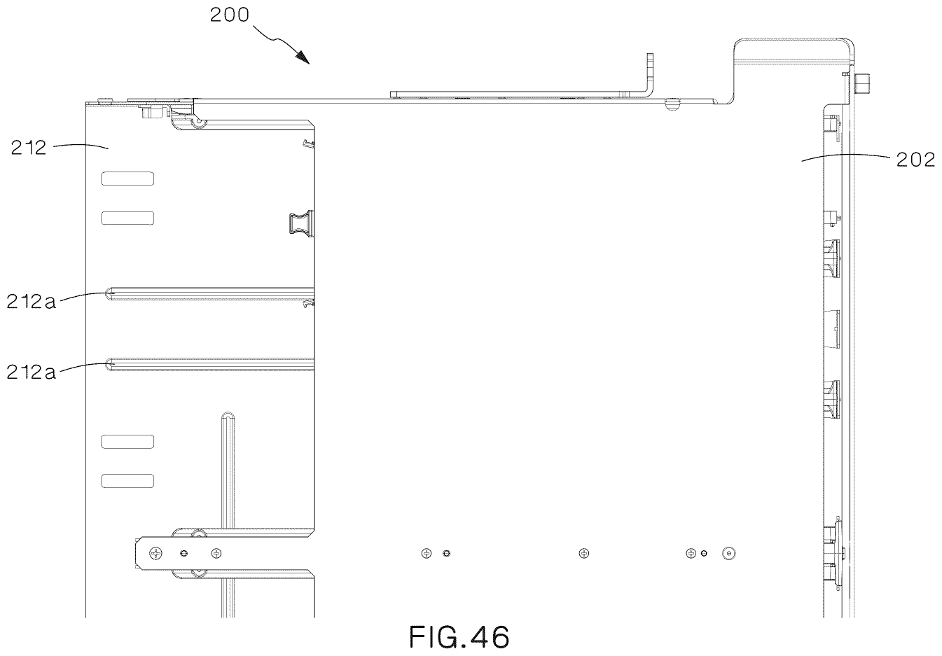

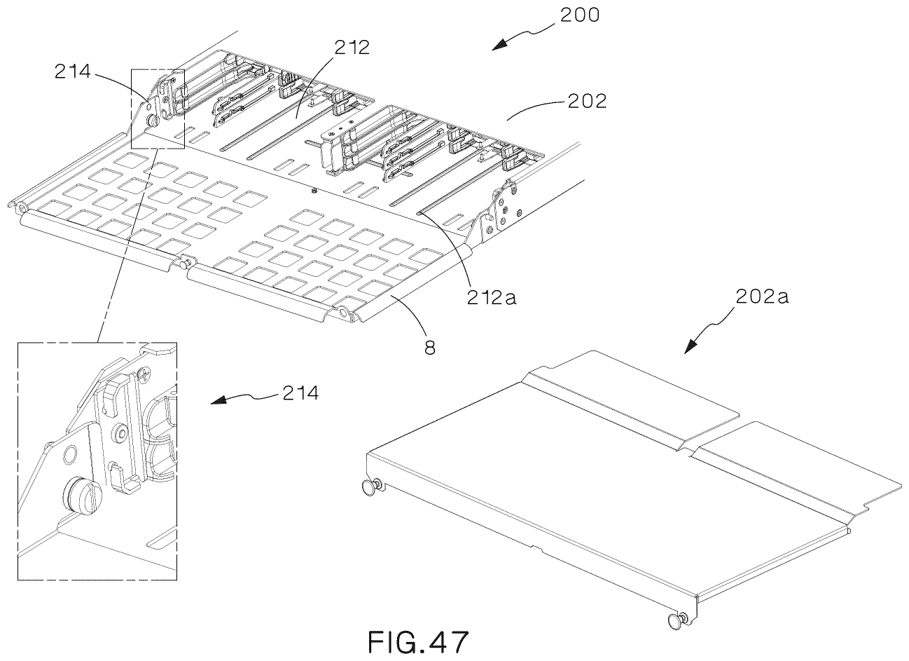

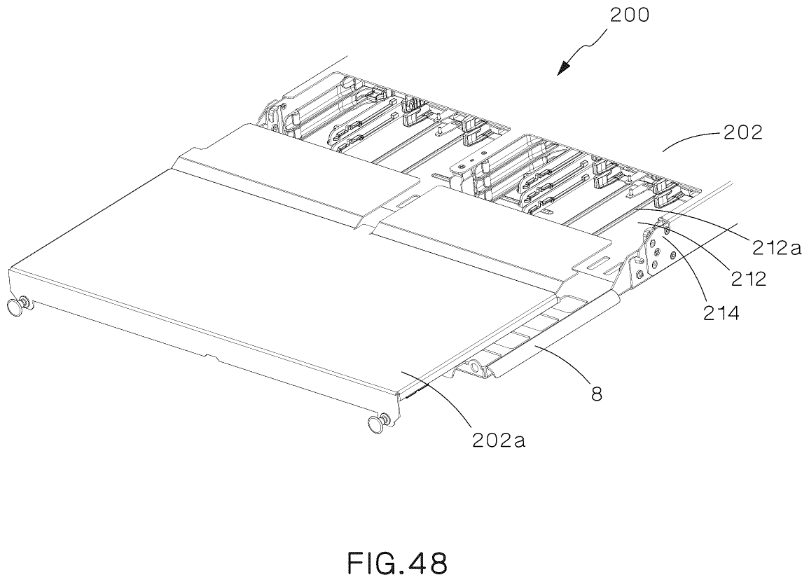

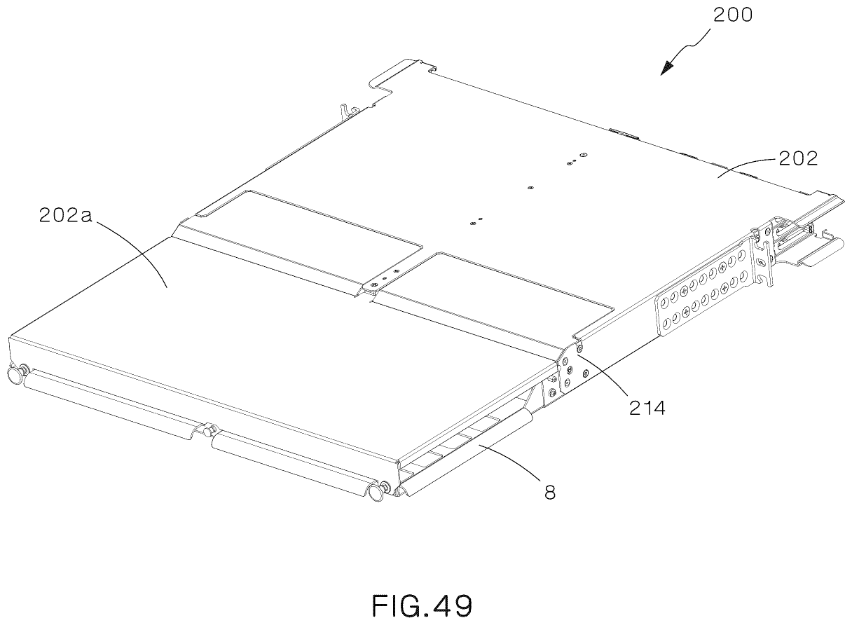

As shown in FIGS. 46-47, the top cover 202 of the HDFE enclosure 200 is cut away above the mounting for cable slack management 212. In one embodiment of the disclosed invention, this cut away portion may be covered by a removable top cover 202a as shown in FIGS. 47-49.

The sets of cutout features 240 in the HDFE modular tray 220 and protrusions on the HDFE removable rail 280 may be slightly different so that only a particular HDFE removable rail 280 may be secured within a set of cutout features 240 as previously described with respect to the patch panel embodiment. For example, the middle set of cutouts 246 may be disposed slightly closer to the front of the HDFE modular tray 220 than the left and right sets of cutouts 242, 244, and the protrusions on the HDFE removable rail 280 may be disposed closer to the front of the HDFE removable rail 280.

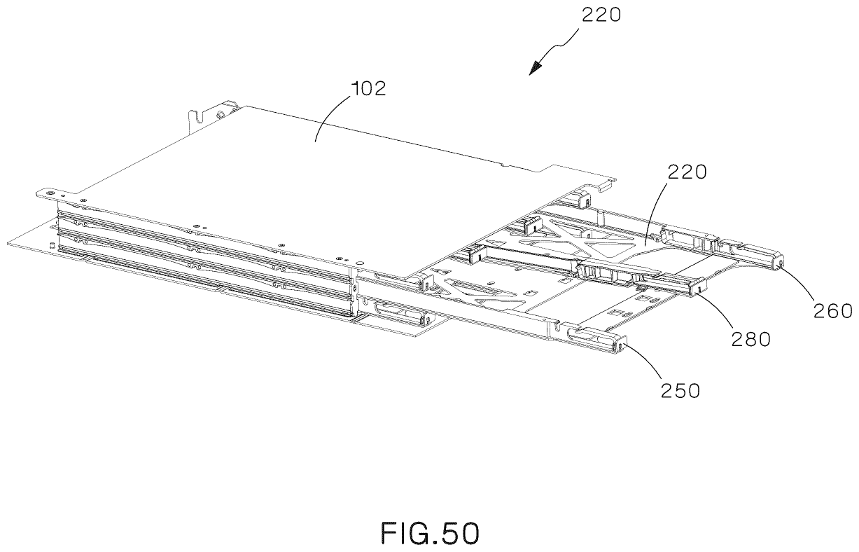

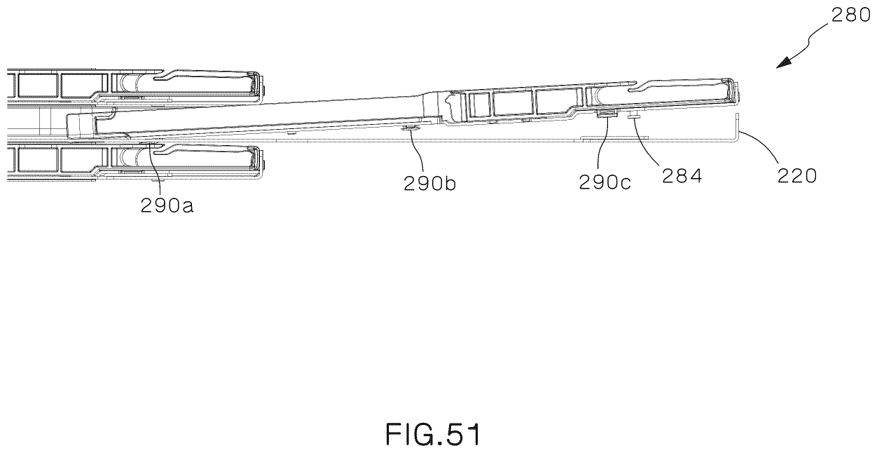

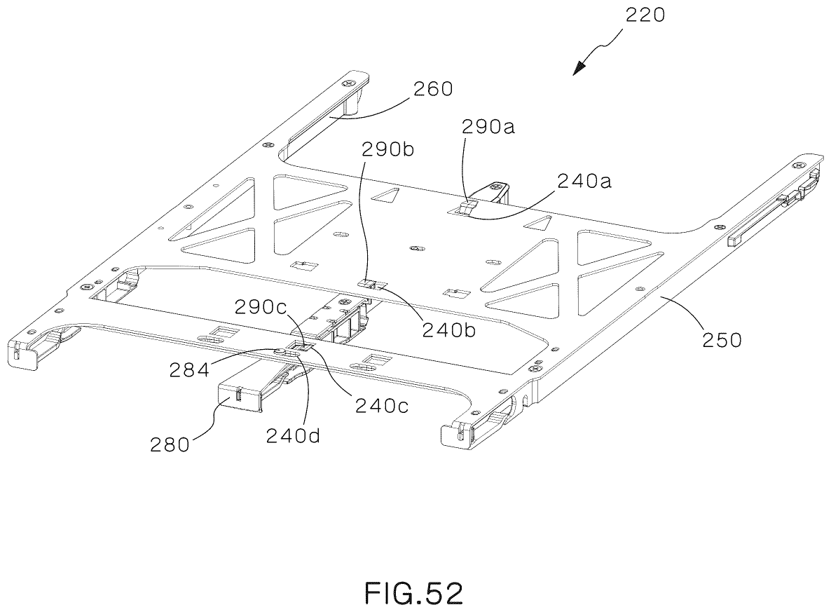

Referring now to FIGS. 50-52, in order to insert the HDFE removable rail 280 into the HDFE modular tray 220, a user first positions the HDFE removable rail 280 so that all of the protrusions 290a, 290b, 290c and the self-clinching keyhole fastener 284 are disposed within one set of cutout features 240. The user then pushes the removable rail 280 toward the rear of the HDFE tray 220 to seat the rear-most protrusion 290a into rear of the rear-most cutout 240a. Maintaining the protrusions 290a, 290b, 290c and self-clinching keyhole fastener 284 in corresponding cutouts 240a, 240b, 240c, and 240d, the user then rotates the HDFE removable rail 280 so that the middle protrusion 290b is moved into the smaller portion of the middle cutout 240b. As this occurs, the front latch 290c seats within the latch-receiving cutout 240c to secure the HDFE removable rail 280 in the HDFE modular tray. The self-clinching keyhole fastener 284 seats in cutout 240d at this time as well. In order to remove the HDFE removable rail, the user depresses and releases the front latch 290c, rotates the HDFE removable rail 280 slightly so that the front latch 290c, middle protrusion 290b, and self-clinching keyhole fastener 284 are no longer seated in the latch-receiving cutout 240c, the smaller portion of the middle cutout 240b, and the smaller portion of forward most cutout feature 240d. The user then pulls HDFE removable rail 280 slightly forward, lifts, and removes the HDFE removable rail 280 from the HDFE modular tray 220.

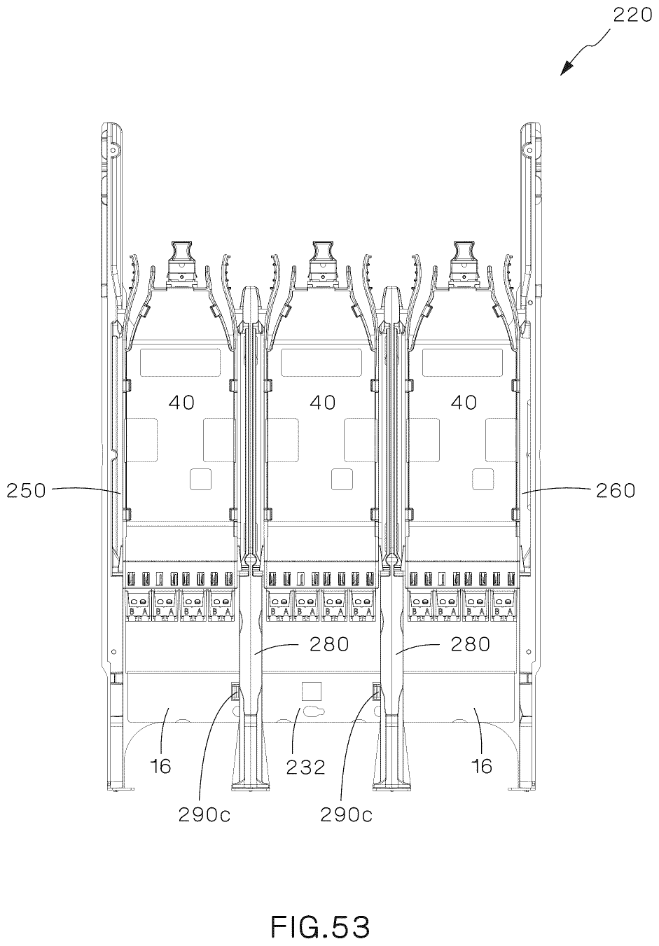

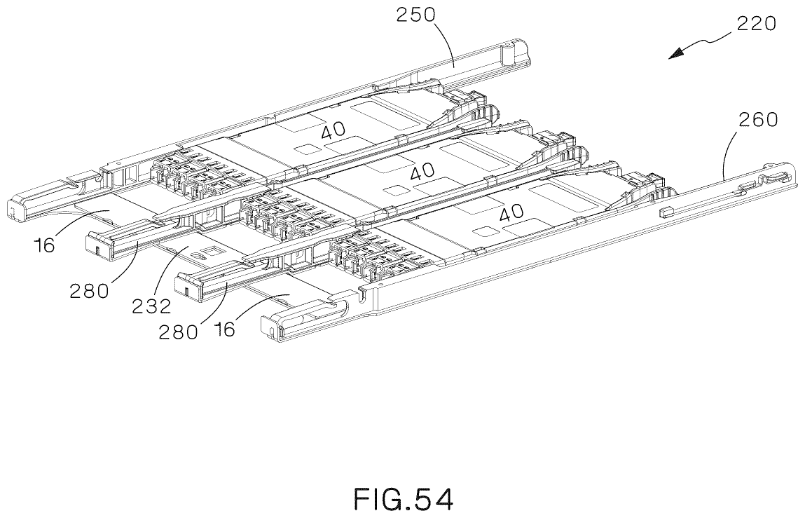

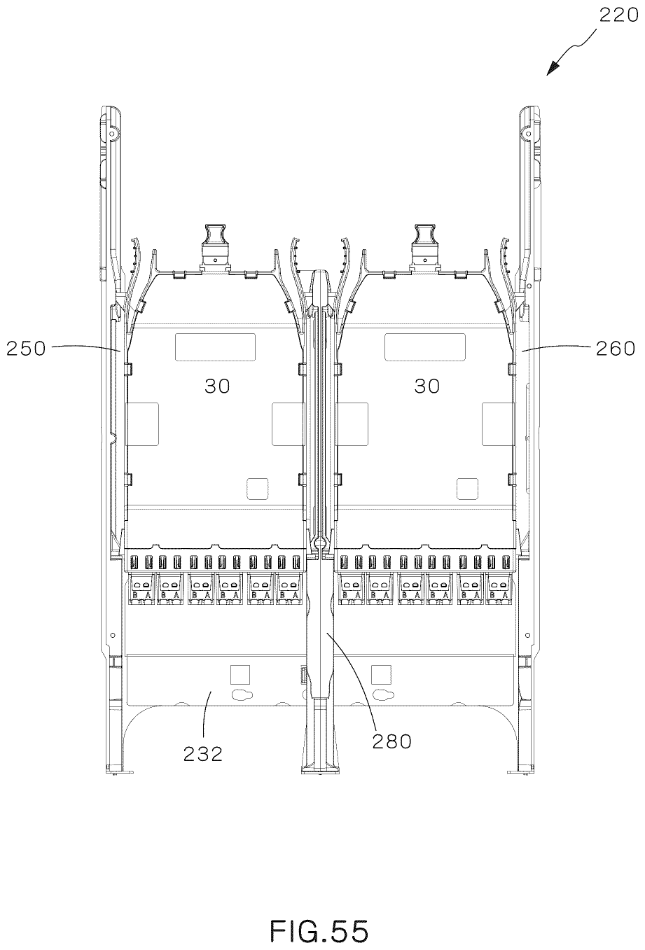

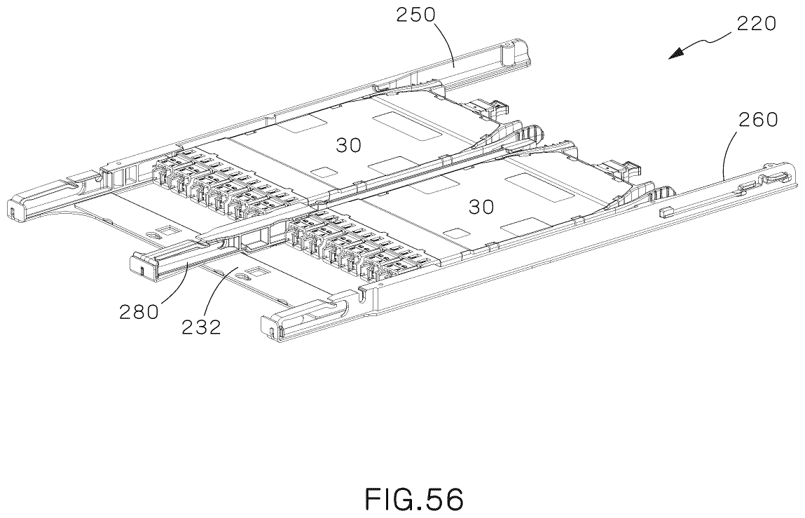

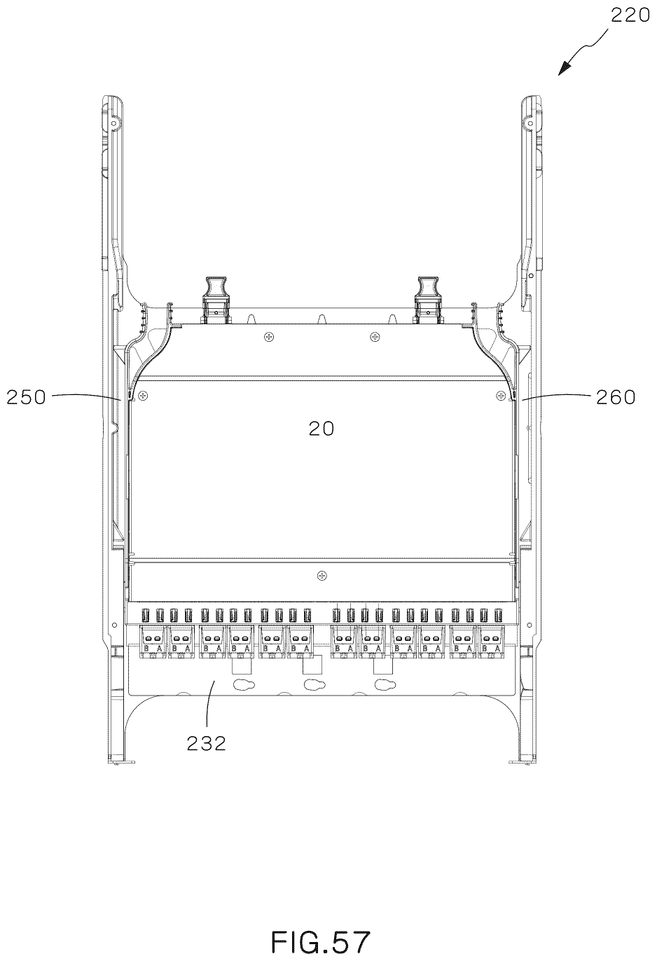

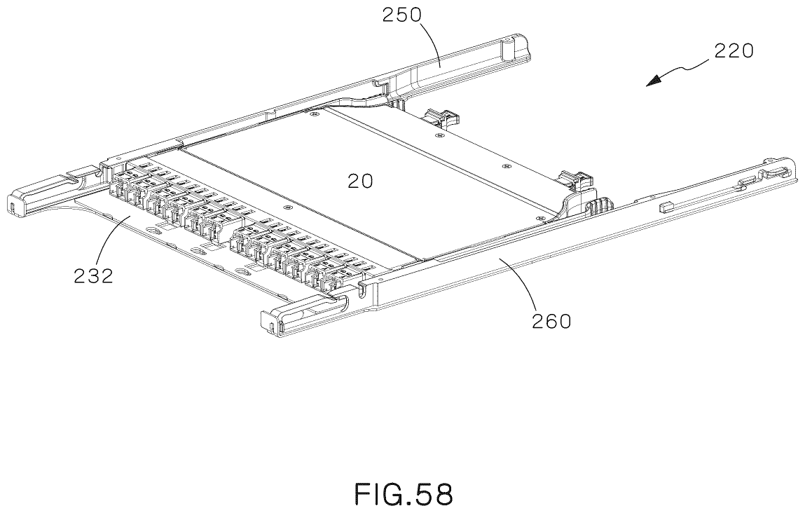

Preferably, three sets of cutout features 240 are disposed on the HDFE tray. One middle set of cutout features 246 is disposed along the midline between the left and right rails 250, 260, so that, when a removable rail 280 is installed within the middle set of cutout features 246, two 12-optical fiber modules 30 may be installed on either side of the removable rail 280 as shown in FIGS. 55-56. Two additional sets of cutout features, left set of cutout features 244 and right set of cutout features 242, are disposed on either side of the middle set of cutout features 246 so that, when removable rails 280 are installed in both the left set of cutout features 244 and right set of cut out features 242, three 8-optical fiber modules 40 may be installed into the HDFE tray 220 as shown in FIGS. 53-54. Finally, when no removable rails 280 are installed in the HDFE tray 220, one 24-optical fiber module 20 may be installed between the left rail 250 and right rail 260 as shown in FIG. 57-58.

One of ordinary skill in the art would understand that the cutout features 140 and removable rails 180 described with respect to the patch panel 50 could be used within the High Density Fiber Enclosure 200, and that the HDFE cutout features 240 and HDFE removable rail 280 could be used with the patch panel 50. Moreover, one of ordinary skill in the art would understand that differently shaped cutouts and removable rail mount shapes could be used in either the patch panel 50 or High Density Fiber Enclosure 200. These additional modular tray and removable rail designs are contemplated and included within this description.

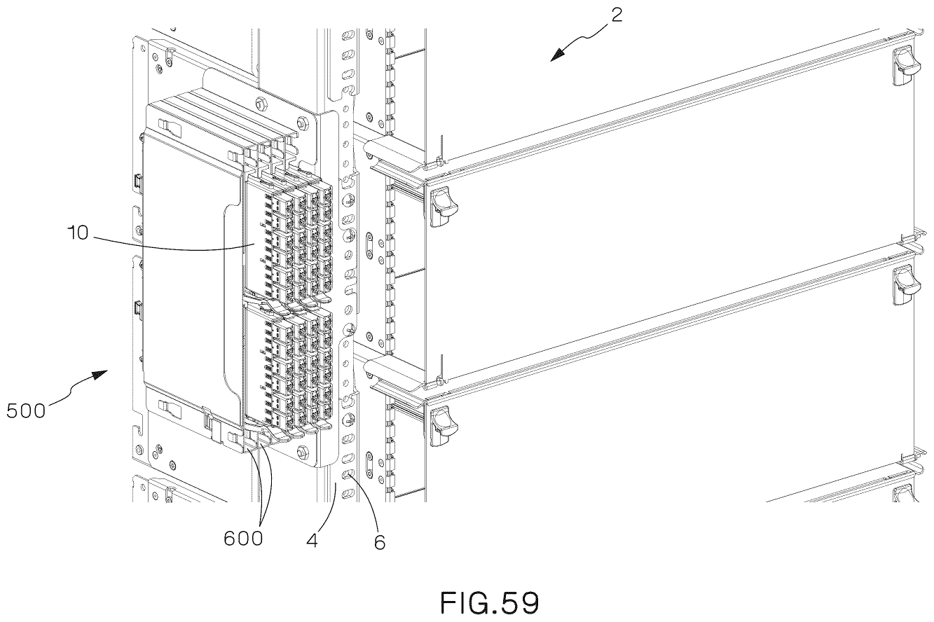

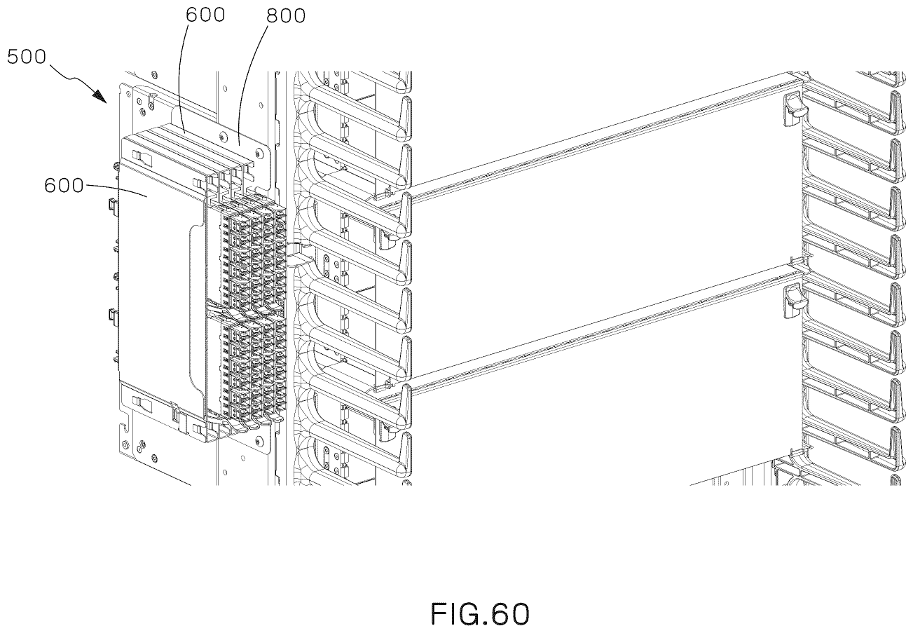

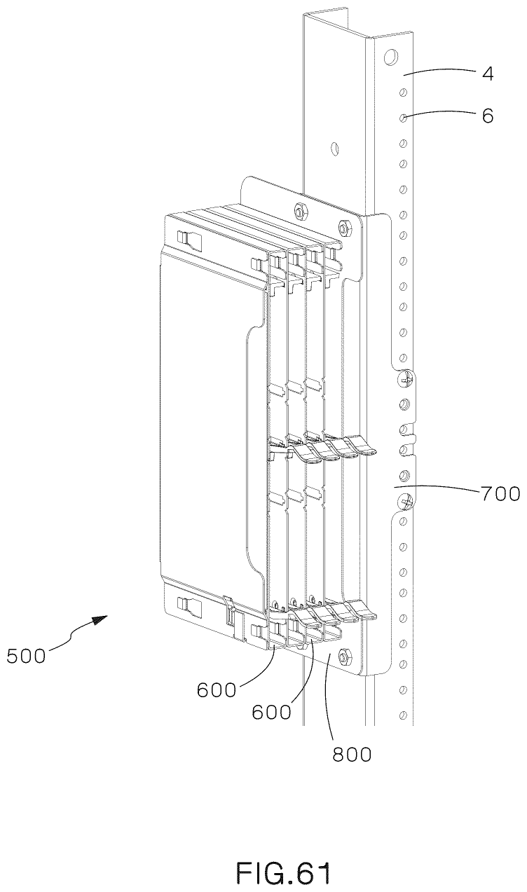

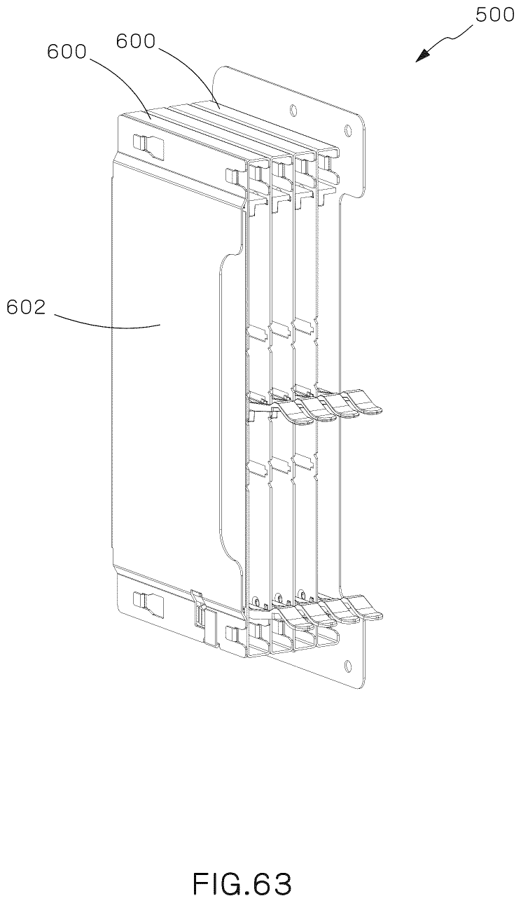

Finally, a modular patch panel that may include removable rails described above is also disclosed. Referring now to FIGS. 59-63, the modular patch panel 500 includes at least one unit 600 that can be attached to a fiber optic enclosure equipment rail 4 or another unit 600, a post mounting bracket 700, and a mounting plate 800. A unit 600 includes four hooks 610, four openings 612, a cantilever latch 614, a mating hole 616, and a cutout 618. The four hooks 610 are disposed on the top portion 602 of the unit 600. Two of the hooks 610 are disposed on the left edge 606 of the unit 600 so that the hooks face the same direction. Two of the hooks 610 are disposed on the right edge 608 of the unit 600 so that the hooks 610 face the same direction as the hooks 610 disposed on the left edge 606 of the unit 600. The four holes 612 are disposed through the bottom portion 604 of the unit 600. The holes 612 are configured to slidably receive the four hooks 610 of a different unit 600 to secure the units 600 together. One of ordinary skill in the art would understand, and it is contemplated in this invention, that hooks 610 of different shapes, or even posts or other protrusions, could be used to engage with holes 612.

The cantilever latch 614 is disposed between two of the hooks 610 on the right edge 608 of the unit 600 and includes a cantilevered portion 620. The cantilevered portion 620 faces the opposite direction of the hooks 610 and is configured to lock the units 600 to one another when the hooks 610 are fully installed in the holes 612 by engaging with the mating hole 616 of another unit 600. The mating hole 616 is disposed on the bottom portion 604 of each unit 600, and the cantilever latch 614 is disposed on the top portion 602 of each unit 600. A cutout 618 in each unit 600 allows a user to reach between the units 600 to depress and release the cantilever latch 614. The units 600 may be stacked and secured to one another as discussed below to add additional mounting for fiber optic trays and modules outside a fiber optic enclosure 2.

The bottom-most unit 600 can be attached to a fiber optic equipment enclosure rail 4 by using a post mounting bracket 700 and a mounting plate 800. The post mounting bracket 700 is designed to be secured to the fiber optic equipment enclosure rail 4 using the mounting holes already existing in the enclosure rail 4. The mounting plate 800 is secured to the post mounting bracket 700 and includes four hooks 810 and a cantilever latch 814. The hooks 810 and cantilever latch 814 are all configured to be the same as the hooks 610 and cantilever latch 614. A unit 600 may also include a label card 902 and label card holder 900 for identifying the particular unit 600.

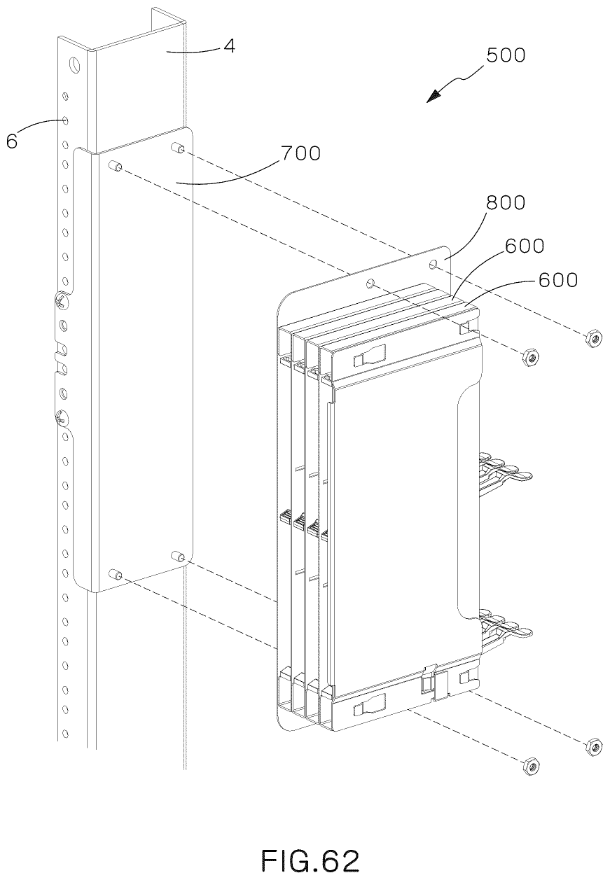

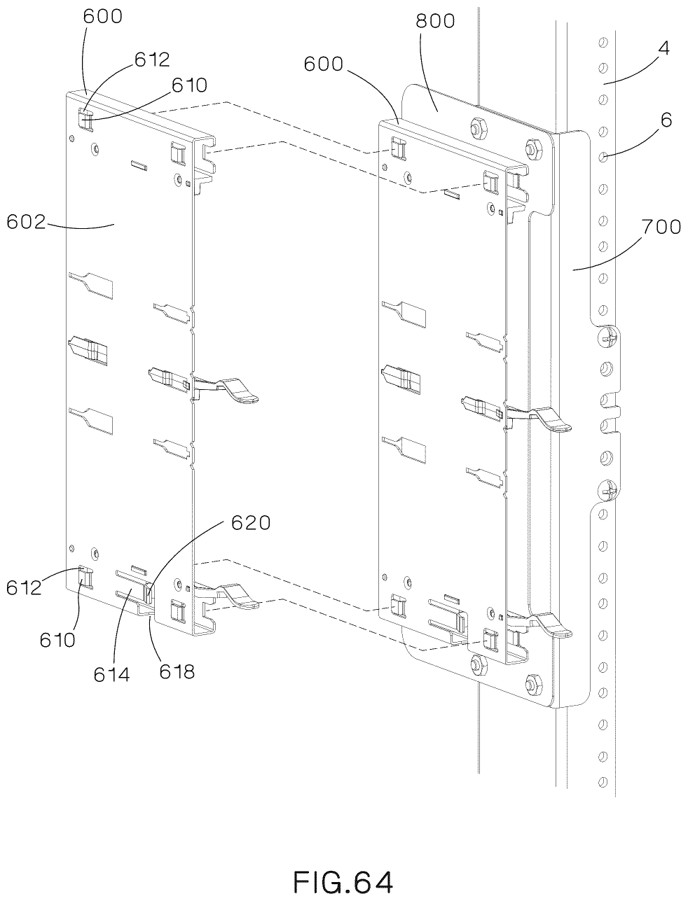

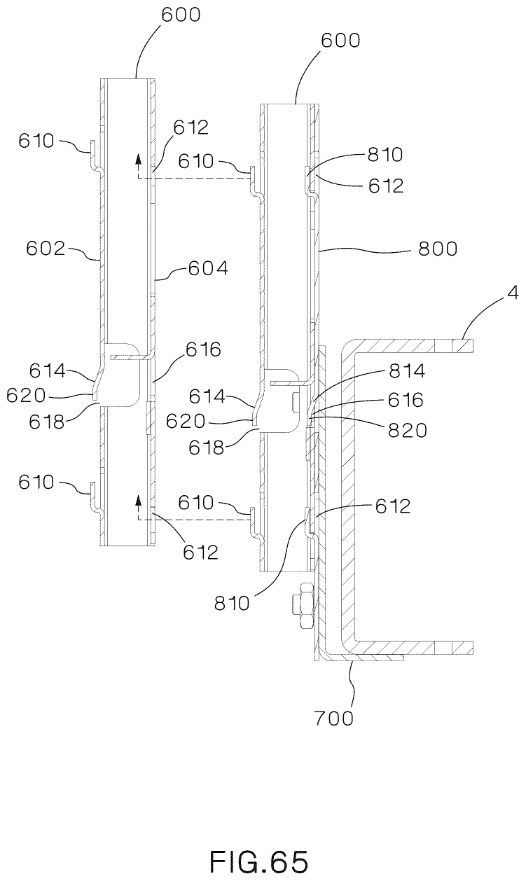

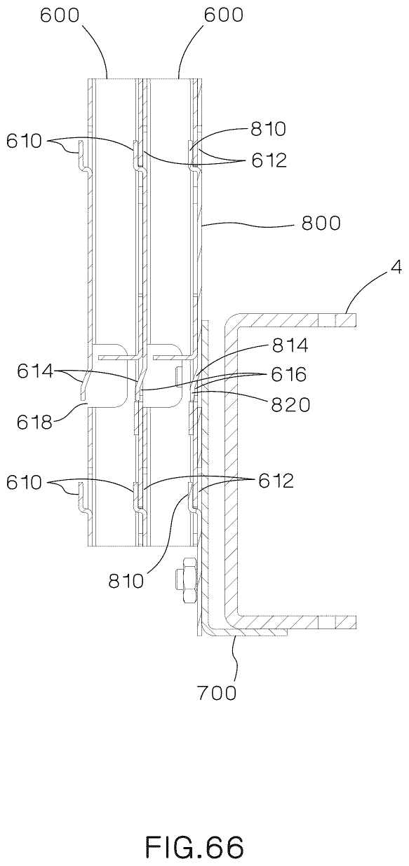

Referring now to FIGS. 64-66, to install a set of units 600 on the front or rear face of an equipment rail 4 of a fiber optic enclosure 2, the user first installs the post mounting bracket 700 using the pre-existing mounting holes on the fiber optic equipment enclosure rail 2, corresponding holes on the post mounting bracket 700, and bolts or screws to secure the post mounting bracket 700 to the rail 4 as shown in FIG. 62. A user then installs the mounting plate 800 onto the post mounting bracket 700 using bolts or screws. Once the post mounting bracket 700 and mounting plate 800 are secure, the user can attach a first unit 600 to the mounting plate 800 by positioning the mounting holes 612 of the unit 600 over the hooks 810 of the mounting plate 800. The user then slides the unit 600 with respect to the mounting plate 800 so that the edge of each the mounting holes 612 is positioned within the crook of each of the hooks 810. When the edge of the mounting holes 612 touches the back of the hooks 810, the cantilever latch 814 of the mounting plate 800 is positioned within the mating hole 616 of the unit 600 and the cantilevered portion 820 abuts the edge of the mating hole 616 to secure the unit 600 to the mounting plate 800. The first unit 600 may be pre-installed by a manufacturer on the post mounting bracket 700 and mounting plate 800, such that a user may simultaneously install the first unit 600, mounting bracket 700, and mounting plate 800. A second unit 600 may be installed on the first unit 600 by positioning the hooks 610 of the first unit within the mounting holes 612 of the second unit 600 and sliding the second unit 600 relative to the first unit 600 until the hooks 610 and cantilever latch 614 are positioned in their corresponding holes as discussed above.

To remove a unit 600 from a stack of units 600 installed together, the user uses his hand or a tool to depress the cantilever latch 614 and release the top-most unit 600. The user then slides the unit 600 until the hooks 610 no longer engage the mounting holes 612. The unit 600 may then be removed from the stack of units 600.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation.

What is claimed is:

1. A fiber management system comprising:
a tray comprising:
a first rail positioned at a first side end of the tray;
a second rail positioned at a second side end of the tray;
a tray body surface that extends from the first side end to the second side end, the tray body including a middle portion between the first rail and the second rail; and
at least one latch rail positioned on the middle portion, the at least one latch rail including a front stop latch at a front end of the latch rail; and
a fiber module comprising:
a first side wall including a front post positioned near a front end of the fiber module, the front post configured to engage the front stop latch;
a second side wall;
a front mounting face, the front mounting face including a front opening configured to receive a front-side fiber component; and
a rear wall including a rear opening.

2. The fiber management system of claim 1, wherein the front stop latch is configured to flex in a direction that is perpendicular to an installation direction of the fiber module when the front post engages the front stop latch.

3. The fiber management system of claim 1, the rear wall further a rear handle that protrudes out from the rear wall.

4. The fiber management system of claim 3, wherein the at least one rear handle is positioned between the rear opening and an outer edge of the rear wall.

5. The fiber management system of claim 1, the rear wall further including a first rear handle and a second rear handle, the first rear handle positioned on a first side of the rear opening and the second rear handle positioned on a second side of the rear opening.

6. The fiber management system of claim 1, wherein the at least one latch rails includes at least three latch rails.

7. The fiber management system of claim 1, wherein the at least one latch rails includes a single latch rail.

8. The fiber management system of claim 1, wherein the fiber module is configured for both front-side and rear-side installation on the tray.

9. The fiber management system of claim 1, wherein the rear opening is configured to receive a rear-side fiber component.

10. The fiber management system of claim 9, wherein the rear-side fiber component is a multi-fiber component.

11. The fiber management system of claim 1, wherein the front-side fiber component is a multi-fiber component.
